(19) United States
(12) Patent Application Publication
(10) Pub. No.: US 2026/0333107 A1
(43) Pub. Date: Oct. 22, 2026

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Zhe FU, Dongguan (CN); Qianxi LU, Dongguan (CN)

(21) Appl. No.: 19/704,313

(22) Filed: Jun. 10, 2026

Related U.S. Application Data
(63) Continuation of application No. PCT/CN2023/142143, filed on Dec. 26, 2023.

(51) Int. Cl. H04W 28/02; H04W 28/10

(52) U.S. Cl. CPC H04W 28/0205; H04W 28/10

(57) ABSTRACT

Provided is a wireless communication method, which includes: transmitting, by a second device to a first device, first information, where the first information is associated with synchronous transmission or coordinated transmission of at least one object.

### CROSS-REFERENCE TO RELATED APPLICATION

This application is a Continuation Application of International Application No. PCT/CN2023/142143 filed on Dec. 26, 2023, which is incorporated herein by reference in its entirety.

### TECHNICAL FIELD

The present application relates to the field of communication technologies, and more specifically, to a wireless communication method and a communication device.

### RELATED ART

In some scenarios, multiple objects need to be presented to a user in a synchronous or coordinated manner. Currently, the synchronization of multiple objects can only be performed at the application layer, which means that the multiple received objects are buffered at the application layer and presented to the user in a synchronous or coordinated manner based on timestamps of the multiple objects. However, this solution of buffering multiple objects at the application layer imposes certain requirements on the storage space of the device, thereby limiting the scenarios in which the solution is applicable.

In some scenarios, multiple objects may include multi-modality flows. Typically, multi-modality flows may include a voice data flow, a video data flow, and a subtitle data flow, which need to be presented to the user synchronously. That is, the multi-modality flows need to be presented to the user in a synchronous or coordinated manner. Currently, the synchronization of multi-modality flows can only be performed at the application layer. This involves buffering the received multi-modality flows at the application layer, extracting data frames of different data flows from the multi-modality flows based on the timestamps for displaying the data flows, and displaying the data frames of the different data flows to the user synchronously. However, this solution of buffering multi-modality flows at the application layer imposes certain requirements on the storage space of the device, thereby limiting the scenarios in which the solution is applicable.

### SUMMARY

The present application provides a wireless communication method and a communication device. The various aspects of the present application are described below.

In a first aspect, a wireless communication method is provided, which includes: transmitting, by a second device to a first device, first information; where the first information is associated with synchronous transmission or coordinated transmission of at least one object.

In a second aspect, a wireless communication method is provided, which includes: receiving, by a first device, first information transmitted by a second device; where the first information is associated with synchronous transmission or coordinated transmission of at least one object.

In a third aspect, a communication device is provided, and the communication device is a second device. The communication device includes: a transmitting unit, configured to transmit first information to a first device, where the first information is associated with synchronous transmission or coordinated transmission of at least one object.

In a fourth aspect, a communication device is provided, and the communication device is a first device. The communication device includes: a receiving unit, configured to receive first information transmitted by a second device, where the first information is associated with synchronous transmission or coordinated transmission of at least one object.

In a fifth aspect, a communication device is provided, which includes: a processor, a memory, and a communication interface. The memory is configured to store one or more computer programs, and the processor is configured to invoke the computer program(s) in the memory to cause the communication device to perform some or all of the steps in the method in the first aspect.

In a sixth aspect, a communication device is provided, which includes: a processor, a memory, and a transceiver. The memory is configured to store one or more computer programs, and the processor is configured to invoke the computer program(s) in the memory to cause the communication device to perform some or all of the steps in the method in the second aspect.

In a seventh aspect, an embodiment of the present application provides a communication system, which includes the aforementioned communication devices. In another possible design, the system may further include other devices that communicate with the communication device in the solutions provided by the embodiments of the present application.

In an eighth aspect, an embodiment of the present application provides a non-transitory computer-readable storage medium, having a computer program stored thereon. The computer program causes a communication device to perform some or all of the steps in the methods in various aspects described above.

In a ninth aspect, an embodiment of the present application provides a computer program product. The computer program product includes a non-transitory computer-readable storage medium having a computer program stored thereon. The computer program is executable to cause a communication device to perform some or all of the steps in the methods in various aspects described above. In some implementations, the computer program product may be a software installation package.

In a tenth aspect, an embodiment of the present application provides a chip, which includes a memory and a processor. The processor can invoke and run a computer program from the memory to implement some or all of the steps described in the methods in the various aspects above.

### BRIEF DESCRIPTION OF THE DRAWINGS

FIG. 1 is a wireless communication system 100 to which embodiments of the present application are applied.

FIG. 2 is a schematic flowchart of a wireless communication method according to an embodiment of the present application.

FIG. 3 is a schematic diagram of a service data adaptation protocol (SDAP) control protocol data unit (PDU) in an embodiment of the present application.

FIG. 4 is a schematic diagram of an SDAP control PDU in another embodiment of the present application.

FIG. 5 is a schematic diagram of an SDAP control PDU in another embodiment of the present application.

FIG. 6 is a schematic diagram of the structure of an SDAP data PDU in an embodiment of the present application.

FIG. 7 is a schematic diagram of the structure of an SDAP data PDU in an embodiment of the present application.

FIG. 8 is a schematic flowchart of a wireless communication method in Embodiment 1 of the present application.

FIG. 9 is a schematic flowchart of a wireless communication method in Embodiment 2 of the present application.

FIG. 10 is a schematic diagram of a communication device according to an embodiment of the present application.

FIG. 11 is a schematic diagram of a communication device according to an embodiment of the present application.

FIG. 12 is a schematic block diagram of a communication apparatus according to an embodiment of the present application.

### DETAILED DESCRIPTION

The technical solutions in the present application will be described below with reference to the accompanying drawings.

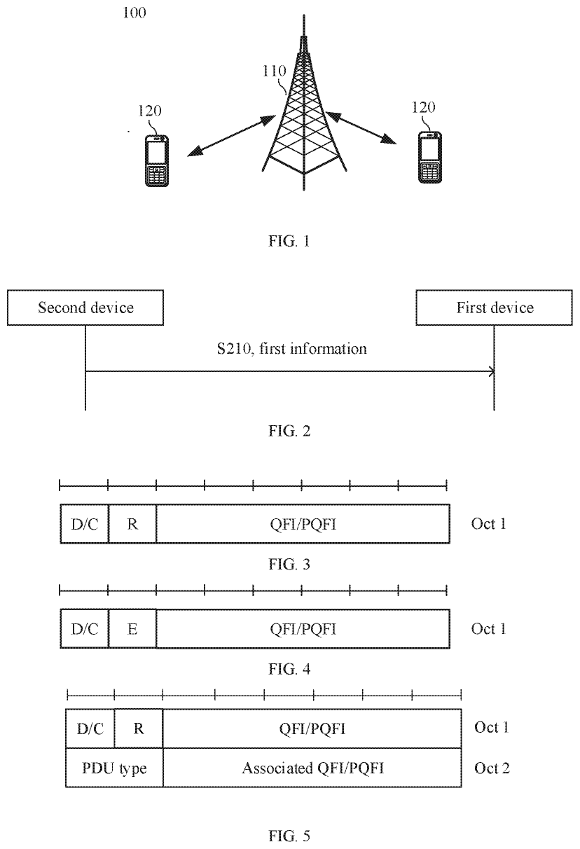

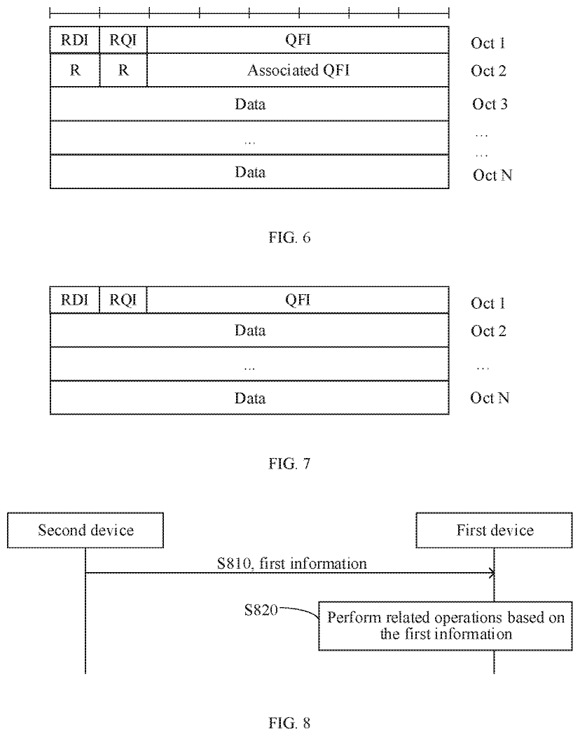

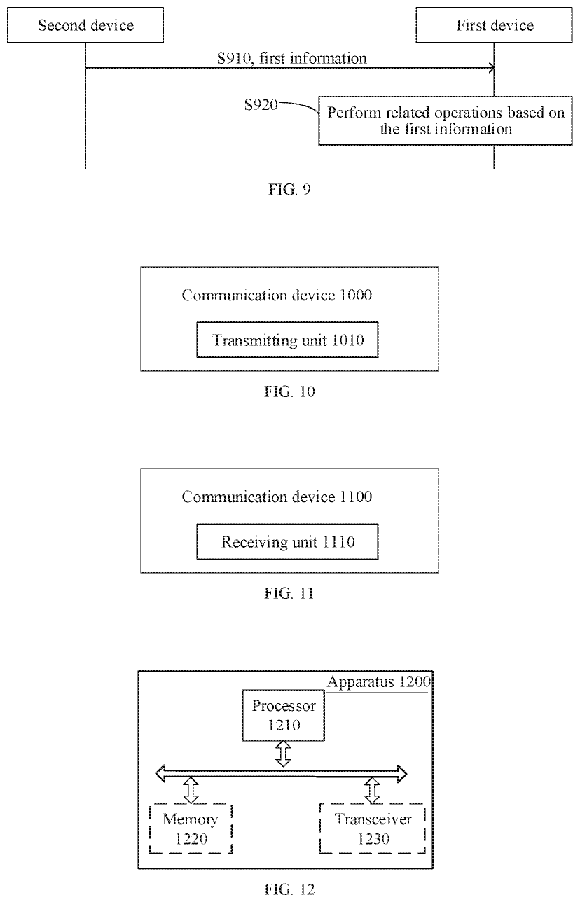

FIG. 1 shows a wireless communication system 100 to which embodiments of the present application are applied. The wireless communication system 100 may include a network device 110 and a terminal device 120. The network device 110 may be a device that communicates with the terminal device 120. The network device 110 can provide communication coverage for a specific geographical area and can communicate with the terminal device 120 located within the coverage area.

FIG. 1 exemplarily shows one network device and two terminal devices. Optionally, the wireless communication system 100 may include multiple network devices, and within the coverage area of each network device, there may be other numbers of terminal devices, which is not limited in the embodiments of the present application.

Optionally, the wireless communication system 100 may also include other network entities such as a network controller and a mobility management entity, which is not limited in the embodiments of the present application.

It should be understood that the technical solutions of the embodiments of the present application can be applied to various communication systems, such as a 5th generation (5G) system or new radio (NR), a long term evolution (LTE) system, an LTE frequency division duplex (FDD) system, and an LTE time division duplex (TDD) system. The technical solutions provided in the present application may also be applied to future communication systems, such as a 6th generation mobile communication system, or a satellite communication system.

The terminal device in the embodiments of the present application may also be referred to as a user equipment (UE), an access terminal, a user unit, a user station, a mobile station, a mobile station (MS), a mobile terminal (MT), a remote station, a remote terminal, a mobile device, a user terminal, a terminal, a wireless communication device, a user agent, or a user apparatus. The terminal device in the embodiments of the present application may refer to a device that provides voice and/or data connectivity to a user, and can be used to connect people, things, and machines, such as a handheld device or a vehicle-mounted device, both having wireless connection capabilities. The terminal device in the embodiments of the present application may be a mobile phone, a tablet computer (Pad), a notebook computer, a personal digital assistant (PDA), a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, or a wireless terminal in a smart home, etc. Optionally, a UE may act as a base station. For example, a UE can act as a scheduling entity that provides sidelink signals between UEs in V2X or D2D. For example, a cellular phone and a car communicate with each other using sidelink signals. A cellular phone can directly communicate with a smart home device without the need for a base station to relay communication signals.

The network device in the embodiments of the present application may be a device used to communicate with a terminal device. The network device may also be referred to as an access network device or a radio access network device, for example, the network device may be a base station. The network device in the embodiments of the present application may refer to a radio access network (RAN) node (or device) that connects a terminal device to a wireless network. The term base station can broadly cover or be substituted with various names such as: NodeB, evolved NodeB (eNB), next generation NodeB (gNB), relay station, access point, transmitting and receiving point (TRP), transmitting point (TP), master eNB (MeNB), secondary eNB (SeNB), multi-standard radio (MSR) node, home base station, network controller, access node, wireless node, access point (AP), transmission node, transceiver node, baseband unit (BBU), remote radio unit (RRU), active antenna unit (AAU), remote radio head (RRH), central unit (CU), distributed unit (DU), and positioning node. A base station can be a macro base station, a micro base station, a relay node, a donor node, or a combination thereof. A base station can also refer to a communication module, modem, or chip installed in the aforementioned devices or apparatuses. A base station can also be a mobile switching center, a device performing base station functions in device-to-device (D2D) communication, vehicle-to-everything (V2X) communication or machine-to-machine (M 2M) communication, a network-side device in a 6G network, a device performing base station functions in a future communication system, etc. A base station can support networks with the same or different access technologies. The embodiments of the present application do not limit the specific technology or the specific device form of the network device.

The base station may be fixed or mobile. For example, a helicopter or a drone may be configured to act as a mobile base station, and one or more cells can move with the position of the mobile base station. In other examples, a helicopter or a drone may be configured to act as a device that communicates with another base station.

In some deployments, the network device in the embodiments of the present application may refer to a CU or a DU, or the network device may include a CU and a DU. A gNB may also include an AAU.

The network device and the terminal device may be deployed on land, including indoors or outdoors, handheld or vehicle-mounted; alternatively, they may be deployed on the water; alternatively, they may be deployed on aircraft, balloons, or satellites in the air. The embodiments of the present application do not limit the scenarios in which the network device and the terminal device are located.

It should be understood that all or part of the functions of the communication devices in the present application can also be implemented by software functions running on hardware, or by virtualized functions instantiated on a platform (e.g., a cloud platform).

### Application Scenarios of Communication Systems

Currently, the main application scenarios of communication systems (e.g., 5G) may include enhanced mobile broadband (eMBB), ultra reliable low latency communication (URLLC), and massive machine-type communication (mMTC). eMBB can be applied to scenarios where users obtain multimedia content, services, and data, and the demand for eMBB is growing rapidly. In addition, eMBB may be deployed in different environments, such as indoors, urban areas, and rural areas, and the capabilities and requirements for eMBB also vary significantly in different environments.

URLLC can be applied to scenarios such as industrial automation, power automation, remote medical operations (surgery), and transportation safety assurance. Typical characteristics of mMTC include high connection density, small data volume, delay-insensitive services, and low cost and long lifespan of modules.

### Radio Resource Control (RRC) State and Mobility Management

Currently, the protocol defines three RRC states for a terminal device: RRC_connected, RRC_idle, and RRC_inactive.

RRC_connected state can refer to the state of the terminal device after completing the random access procedure and before an RRC release. An RRC connection exists between the terminal device and a network device (e.g., an access network device). In the RRC_connected state, the terminal device and network device can perform data transmission, such as downlink data transmission and/or uplink data transmission. Alternatively, the terminal device and network device can also perform transmission on a terminal-device-specific data channel and/or control channel to transmit specific information or unicast information for the terminal device.

In the RRC_connected state, the network device can determine the cell-level location information of the terminal device; that is, the network device can determine the cell to which the terminal device belongs. In the RRC_connected state, after the terminal device undergoes a change in location due to movement, for example, moves from one cell to another, the network device can control the terminal device to perform a cell handover. It can be seen that mobility management for a terminal device in the RRC_connected state may include the cell handover. In addition, the network device can control the mobility management for the terminal device in the RRC_connected state, and accordingly, the terminal device can hand over to a specified cell according to an instruction issued by the network device.

RRC_idle state refers to the state of the terminal device when it is camping on a cell but has not performed random access. A terminal device usually enters the RRC_idle state after power-on or after an RRC release. In the RRC_idle state, there is no RRC connection between the terminal device and the network device (e.g., the camped network device); the network device does not store the context of the terminal device, and no connection for the terminal device is established between the network device and the core network. If the terminal device needs to transition from the RRC_idle state to the RRC_connected state, it needs to initiate an RRC connection establishment procedure.

In the RRC_idle state, the core network (CN) can transmit a paging message to the terminal device; that is, the paging procedure can be triggered by the CN. Optionally, the paging area can also be configured by the CN. In some cases, for a terminal device in the RRC_idle state, when the terminal device undergoes a change in location due to movements (e.g., moves from one cell to another), it can initiate a cell reselection procedure. In other cases, for a terminal device in the RRC_idle state, when the terminal device needs to access a cell, it can initiate a cell selection procedure. That is, the mobility management for a terminal device in the RRC_idle state may include cell reselection and/or cell selection.

RRC_inactive state is a state defined to reduce air interface signaling, quickly resume wireless connections, and quickly resume data services. The RRC_inactive state is a state between the connected state and the idle state. The terminal device has previously entered the RRC_connected state and then released the RRC connection with the network device, but the network device has saved the context of the terminal device. In addition, the connection established between the network device and the core network for this terminal device has not been released; that is, the user plane bearer and control plane bearer between the RAN and the CN are still maintained, meaning that a CN-NR connection exists.

In the RRC_inactive state, the RAN can transmit a paging message to the terminal device; that is, the paging procedure can be triggered by the RAN. The RAN-based paging area is managed by the RAN, and the network device can know the location of the terminal device at the RAN-based paging area level.

In some cases, for a terminal device in the RRC_inactive state, when the terminal device undergoes a change in location due to movements (e.g., moves from one cell to another), it can initiate a cell reselection procedure. In other cases, for a terminal device in the RRC_inactive state, when the terminal device needs to access a cell, it can initiate a cell selection procedure. That is, the mobility management for a terminal device in the RRC_inactive state may include cell reselection and/or cell selection.

### XR

In some meetings (e.g., the 3GPP RAN #88e meeting), a study item named “Study on XR (eXtended Reality) and cloud game (CG) enhancements for NR” was proposed. The XR services studied in this project may include augmented reality (AR) and virtual reality (VR). A major service in XR and/or CG services is the video stream service, which has high requirements for transmission rates. For example, the transmission rate requirement for video stream services, measured in frames per second (fps), may be 30 fps, 60 fps, 90 fps, or 120 fps, and the periods corresponding to the video stream services are 33.33 ms, 16.67 ms, 11.11 ms, or 8.33 ms, respectively.

Currently, the characteristics of data in XR services include: the size of data packets corresponding to this service is variable, and the average data packet size is large. For an AR/VR service with a data transmission rate of 100 Mbps, the average uplink data packet size is 20,833 bytes, the maximum is 31,250 bytes, and the minimum is 10,417 bytes. That is, the size of the data packet to be transmitted in each period is ranges from 10,417 bytes to 31,250 bytes. Typically, in a communication system with 100M bandwidth, transmitting a 20,833-byte data packet requires approximately 4 slots.

In some scenarios, it is proposed that multiple PUSCH occasions can be configured within one CG period to transmit data packets with large data volume (also known as “large data packets”) in XR services. In addition, multiple sets of CGs may also be configured to transmit large data packets in XR services. When the data volume of a particular transmission is relatively small, the pre-configured multiple PUSCH occasions may not be occupied. In this case, the terminal device may notify the network device that the PUSCH occasions are unused, and accordingly, the network device may reallocate the unused PUSCH occasions to other terminal devices for data transmission, thereby improving system efficiency.

In some scenarios, multiple objects need to be presented to a user in a synchronous or coordinated manner. Currently, the synchronization of multiple objects can only be performed at the application layer, which means that the multiple received objects are buffered at the application layer and presented to the user in a synchronous or coordinated manner based on timestamps of the multiple objects. However, this solution of buffering multiple objects at the application layer imposes certain requirements on the storage space of the device, thereby limiting the scenarios in which the solution is applicable.

In some scenarios, multiple objects may include multi-modality flows. Typically, multi-modality flows may include a voice data flow, a video data flow, and a subtitle data flow, which need to be presented to the user synchronously. That is, the multi-modality flows need to be presented to the user in a synchronous or coordinated manner. Currently, the synchronization of multi-modality flows can only be performed at the application layer. This involves buffering the received multi-modality flows at the application layer, extracting data frames of different data flows from the multi-modality flows based on the timestamps for displaying the data flows, and displaying the data frames of the different data flows to the user synchronously. However, this solution of buffering multi-modality flows at the application layer imposes certain requirements on the storage space of the device, thereby limiting the scenarios in which the solution is applicable.

Therefore, in response to the above problems, the applicant proposes that synchronous or coordinated transmission can be performed for at least one object (e.g., the aforementioned multi-modality data flows). In this way, the receiving end can directly present the at least one received object to the user, which helps to reduce the requirements on the device's storage space and broaden the scenarios in which the solution is applicable. However, the communication device cannot obtain information related to synchronous or coordinated transmission, for example, the communication device cannot determine which objects need to be transmitted synchronously or coordinately, nor can it determine the parameters for the synchronous or coordinated transmission of the at least one object, resulting in failure to achieve the synchronous or coordinated transmission of the at least one object.

Therefore, in response to the above problems, the applicant proposes a wireless communication method in which a first device and a second device can exchange information associated with the synchronous or coordinated transmission of at least one object (also referred to as “first information”), which facilitates the implementation of synchronous or coordinated transmission of the at least one object.

The wireless communication method according to an embodiment of the present application is described below with reference to FIG. 2. FIG. 2 is a schematic flowchart of the wireless communication method according to an embodiment of the present application. The method shown in FIG. 2 includes step S210.

In step S210, a second device transmits first information to a first device, where the first information is associated with synchronous transmission or coordinated transmission of at least one object.

In this embodiment of the application, the second device can transmit first information to the first device. The first information is associated with synchronous transmission or coordinated transmission of at least one object. This solution facilitates the first device in obtaining the transmission requirements (e.g., synchronous transmission requirement or coordinated transmission requirement) of the at least one object based on the first information, so as to achieve synchronization or coordination of the at least one object during the transmission phase. Compared with conventional solutions that rely on the receiving end to store the at least one object to achieve the synchronous or coordinated transmission of the at least one object, this solution helps to reduce the requirements on the storage space of the receiving end.

In some implementations, the aforementioned coordinated transmission may be understood as that these objects have a cooperative, associated, or dependent relationship in transmission or processing. For example, the coordinated transmission of multiple objects may be understood as completing the transmission or processing of a plurality of objects within a time period. The plurality of objects may include part or all of the objects associated with the first information. Taking coordinated transmission or processing of data flow 1 and data flow 2 for example, and assuming a time period of 5 seconds, then the coordinated transmission or processing can be understood as that the transmission or processing of data flow 1 and data flow 2 is completed within 5 seconds.

In some implementations, the aforementioned synchronous transmission can also be referred to as simultaneous transmission. For example, the synchronous transmission of a plurality of objects can be understood as that the communication or processing of the plurality of objects is performed based on the same clock. The plurality of objects may include part or all of the objects associated with the first information. Taking the synchronous transmission of data flow 1 and data flow 2 for example, the synchronous transmission can be understood as that the transmitting time of data flow 1 is the same as or similar to that of data flow 2. In other examples, the synchronous transmission can be understood as that the receiving, processing, or decoding time of data flow 1 is the same as or similar to the receiving, processing, or decoding time of data flow 2.

Of course, in the embodiments of the present application, synchronous transmission can be understood as transmission within a range segment or a time period, or transmission within a range or a time, or transmission according to a time restriction.

In the embodiments of the present application, the meaning of the term “transmission” is not limited. In some implementations, transmission includes but is not limited to one or more of the following: transmitting, receiving, decoding, demodulating, encoding, displaying, implementation of a specific layer or function, operation of a specific layer or function (e.g., its operation has synchronization requirements, or its operation requires a specific time, time point, or time restriction), or delivery from a specific layer or function to another layer or function.

In the embodiments of the present application, an object is not specifically limited. For example, an object can be one or more of the following: a Quality of Service (QoS) flow, a data flow (e.g., any data flow, an associated data flow, or a multi-modality data flow), a terminal device, a PDU session, a bearer (also known as a radio bearer), a data packet, data, a PDU set, a data burst, a PDU, or an SDU.

When an object is a QoS flow, in some implementations, if the first information is associated with the synchronous transmission of one QoS flow, then the synchronous transmission of one QoS flow may be understood as synchronous transmission of this QoS flow together with other QoS flows. Optionally, the aforementioned one QoS flow may be any QoS flow or a specific QoS flow. If the first information is associated with the synchronous transmission of a plurality of QoS flows, then the synchronous transmission of the plurality of QoS flows may be understood as synchronous transmission among these QoS flows. Of course, in the embodiments of the present application, the synchronous transmission of a plurality of QoS flows may also be understood as synchronous transmission of these QoS flows together with other QoS flows. Here, other QoS flows may be understood as QoS flows other than those associated with the first information, and/or other QoS flows may be QoS flows for which a synchronization requirement exists.

In other implementations, if the first information is associated with the coordinated transmission of one QoS flow, then the coordinated transmission of one QoS flow may be understood as coordinated transmission of this QoS flow together with other QoS flows. Optionally, the aforementioned one QoS flow may be any QoS flow or a specific QoS flow. If the first information is associated with the coordinated transmission of a plurality of QoS flows, then the coordinated transmission of the plurality of QoS flows may be understood as coordinated transmission among these multiple QoS flows. Of course, in the embodiments of the present application, the coordinated transmission of a plurality of QoS flows may also be understood as coordinated transmission of the plurality of QoS flows together with other QoS flows. Here, other QoS flows may be understood as QoS flows other than those associated with the first information, and/or other QoS flows may be QoS flows for which a coordination requirement exists.

When an object is a data flow, in some implementations, if the first information is associated with the synchronous transmission of one data flow, then the synchronous transmission of one data flow may be understood as synchronous transmission of this data flow together with other data flows. Optionally, the aforementioned one data flow may be any data flow or a specific data flow. If the first information is associated with the synchronous transmission of a plurality of data flows, then the synchronous transmission of the plurality of data flows may be understood as synchronous transmission among these data flows. Of course, in the embodiments of the present application, the synchronous transmission of a plurality of data flows may also be understood as synchronous transmission of the plurality of data flows together with other data flows. Here, other data flows may be understood as data flows other than those associated with the first information, and/or other data flows may be data flows for which a synchronization requirement exists.

In other implementations, if the first information is associated with the coordinated transmission of one data flow, then the coordinated transmission associated with one data flow may be understood as coordinated transmission of this data flow together with other data flows. Optionally, the aforementioned one data flow may be any data flow or a specific data flow. If the first information is associated with the coordinated transmission of a plurality of data flows, then the coordinated transmission of the plurality of data flows may be understood as coordinated transmission among these data flows. Of course, in the embodiments of the present application, the coordinated transmission of a plurality of data flows may also be understood as coordinated transmission of the plurality of data flows together with other data flows. Here, other data flows may be understood as data flows other than those associated with the first information, and/or other data flows may be data flows for which a coordination requirement exists.

It should be noted that the data flow may be the aforementioned multi-modality data flow, and accordingly, the first information may be referred to as “multi-modality information.”

When an object is a terminal device, in some implementations, if the first information is associated with the synchronous transmission involving one terminal device, then the synchronous transmission involving one terminal device may be understood as synchronous transmission between this terminal device and other terminal devices. Optionally, the aforementioned one terminal device may be any terminal device or a specific terminal device. If the first information is associated with the synchronous transmission of a plurality of terminal devices, then the synchronous transmission of the plurality of terminal devices may be understood as synchronous transmission among these terminal devices. Of course, in the embodiments of the present application, the synchronous transmission of a plurality of terminal devices may also be understood as synchronous transmission between these terminal devices and other terminal devices. Here, other terminal devices may be understood as terminal devices other than those associated with the first information, and/or other terminal devices may be terminal devices for which a synchronization requirement exists.

In other implementations, if the first information is associated with the coordinated transmission of a single terminal device, the coordinated transmission associated with the single terminal device may be understood as coordinated transmission between the single terminal device and other terminal devices. Optionally, the aforementioned single terminal device may be any terminal device or a specific terminal device. If the first information is associated with the coordinated transmission of a plurality of terminal devices, the coordinated transmission of the plurality of terminal devices may be understood as coordinated transmission among the plurality of terminal devices. In the embodiments of the present application, the coordinated transmission of a plurality of terminal devices may also be understood as coordinated transmission between the plurality of terminal devices and other terminal devices. Here, other terminal devices may be understood as terminal devices other than those associated with the first information, and/or other terminal devices may be terminal devices for which a coordination requirement exists.

When an object is a PDU session, in some implementations, if the first information is associated with the synchronous transmission of a single PDU session, the synchronous transmission of the single PDU session may be understood as synchronous transmission of the single PDU session together with other PDU sessions. Optionally, the aforementioned single PDU session may be any PDU session or a specific PDU session. If the first information is associated with the synchronous transmission of a plurality of PDU sessions, the synchronous transmission of the plurality of PDU sessions may be understood as synchronous transmission among these PDU sessions. In the embodiments of the present application, the synchronous transmission of a plurality of PDU sessions may also be understood as synchronous transmission of the plurality of PDU sessions together with other PDU sessions. Here, other PDU sessions may be understood as PDU sessions other than those associated with the first information, and/or other PDU sessions may be PDU sessions for which a synchronization requirement exists.

In other implementations, if the first information is associated with the coordinated transmission of a single PDU session, the coordinated transmission associated with the single PDU session may be understood as coordinated transmission between said PDU session and other PDU sessions. Optionally, the aforementioned single PDU session may be any PDU session or a specific PDU session. If the first information is associated with the coordinated transmission of a plurality of PDU sessions, the coordinated transmission of the plurality of PDU sessions may be understood as coordinated transmission among the plurality of PDU sessions. In the embodiments of the present application, the coordinated transmission of a plurality of PDU sessions may also be understood as coordinated transmission involving these PDU sessions and other PDU sessions. Here, other PDU sessions may be understood as PDU sessions other than those associated with the first information, and/or other PDU sessions may be PDU sessions for which a coordination requirement exists.

When an object is a bearer, in some implementations, if the first information is associated with the synchronous transmission of a single bearer, the synchronous transmission of the single bearer may be understood as synchronous transmission of the single bearer together with other bearers. Optionally, the aforementioned single bearer may be any bearer or a specific bearer. If the first information is associated with the synchronous transmission of a plurality of bearers, the synchronous transmission of the plurality of bearers may be understood as synchronous transmission among the plurality of bearers. In the embodiments of the present application, the synchronous transmission of a plurality of bearers may also be understood as synchronous transmission of the plurality of bearers together with other bearers. Here, other bearers may be understood as bearers other than those associated with the first information, and/or other bearers may be bearers for which a synchronization requirement exists.

In other implementations, if the first information is associated with the coordinated transmission of a single bearer, the coordinated transmission associated with the single bearer can be understood as coordinated transmission between said bearer and other bearers. Optionally, the aforementioned single bearer may be any bearer or a specific bearer. If the first information is associated with the coordinated transmission of multiple bearers, the coordinated transmission of the multiple bearers can be understood as coordinated transmission among said multiple bearers. In the embodiments of the present application, the coordinated transmission of multiple bearers can also be understood as coordinated transmission between said multiple bearers and other bearers. Here, other bearers can be understood as bearers other than those associated with the first information, and/or other bearers may be bearers for which a coordination requirement exists.

In the embodiments of the present application, the aforementioned bearer is also referred to as a “radio bearer,” which may, for example, include a data radio bearer (DRB). Optionally, in certain scenarios, the bearer can be extended to include a signaling radio bearer (SRB). Correspondingly, the aforementioned synchronous or association relationship can be between SRBs, between an SRB and a DRB, or between DRBs.

When an object is a data packet, in some implementations, if the first information is associated with the synchronous transmission of a single data packet, the synchronous transmission of the single data packet may be understood as synchronous transmission of the single data packet together with other data packets. Optionally, the aforementioned single data packet may be any data packet or a specific data packet. If the first information is associated with the synchronous transmission of a plurality of data packets, the synchronous transmission of a plurality of data packets may be understood as synchronous transmission among the plurality of data packets. In the embodiments of the present application, the synchronous transmission of a plurality of data packets may also be understood as synchronous transmission of the plurality of data packets together with other data packets. Here, other data packets may be understood as data packets other than those associated with the first information, and/or other data packets may be data packets for which a synchronization requirement exists.

In other implementations, if the first information is associated with the coordinated transmission of a single data packet, the coordinated transmission associated with the single data packet may be understood as coordinated transmission of the single data packet together with other data packets. Optionally, the aforementioned single data packet may be any data packet or a specific data packet. If the first information is associated with the coordinated transmission of a plurality of data packets, the coordinated transmission of the plurality of data packets may be understood as coordinated transmission among the plurality of data packets. In the embodiments of the present application, the coordinated transmission of a plurality of data packets may also be understood as coordinated transmission of the plurality of data packets together with other data packets. Here, other data packets may be understood as data packets other than those associated with the first information, and/or other data packets may be data packets for which a coordination requirement exists.

When an object is data, in some implementations, if the first information is associated with the synchronous transmission of a single piece of data, the synchronous transmission of the single piece of data may be understood as synchronous transmission of the single piece of data together with other data. Optionally, the aforementioned single piece of data may be any piece of data or a specific piece of data. If the first information is associated with the synchronous transmission of a plurality of pieces of data, the synchronous transmission of the plurality of pieces of data may be understood as synchronous transmission among the plurality of pieces of data. In the embodiments of the present application, the synchronous transmission of the plurality of pieces of data may also be understood as synchronous transmission of the plurality of pieces of data together with other data. Here, other data may be understood as data other than that associated with the first information, and/or other data may be data with synchronization requirements.

In other implementations, if the first information is associated with the coordinated transmission of a single piece of data, the coordinated transmission associated with the single piece of data may be understood as coordinated transmission of the single piece of data together with other data. Optionally, the aforementioned single piece of data may be any piece of data or a specific piece of data. If the first information is associated with the coordinated transmission of a plurality of pieces of data, the coordinated transmission of the plurality of pieces of data may be understood as coordinated transmission among the plurality of pieces of data. In the embodiments of the present application, the coordinated transmission of a plurality of pieces of data may also be understood as coordinated transmission of the plurality of pieces of data together with other data. Here, other data may be understood as data other than that associated with the first information, and/or other data may be data with coordination requirements.

When an object is a PDU set, in some implementations, if the first information is associated with the synchronous transmission of a single PDU set, the synchronous transmission of the single PDU set may be understood as synchronous transmission of the single PDU set together with other PDU sets. Optionally, the aforementioned single PDU set may be any PDU set or a specific PDU set. If the first information is associated with the synchronous transmission of a plurality of PDU sets, the synchronous transmission of the plurality of PDU sets may be understood as synchronous transmission among the plurality of PDU sets. In the embodiments of the present application, the synchronous transmission of a plurality of PDU sets may also be understood as synchronous transmission of the plurality of PDU sets together with other PDU sets. Here, other PDU sets may be understood as PDU sets other than those associated with the first information, and/or other PDU sets may be PDU sets with synchronization requirements.

In other implementations, if the first information is associated with the coordinated transmission of a single PDU set, the coordinated transmission associated with the single PDU set may be understood as coordinated transmission of the PDU set together with other PDU sets. Optionally, the aforementioned single PDU set may be any PDU set or a specific PDU set. If the first information is associated with the coordinated transmission of a plurality of PDU sets, the coordinated transmission of the plurality of PDU sets may be understood as coordinated transmission among the plurality of PDU sets. In the embodiments of the present application, the coordinated transmission of the plurality of PDU sets may also be understood as coordinated transmission of the plurality of PDU sets together with other PDU sets. Here, other PDU sets may be understood as PDU sets other than those associated with the first information, and/or other PDU sets may be PDU sets with coordination requirements.

When an object is a PDU, in some implementations, if the first information is associated with the synchronous transmission of a single PDU, the synchronous transmission of the single PDU may be understood as synchronous transmission of the single PDU together with other PDUs. Optionally, the aforementioned single PDU may be any PDU or a specific PDU. If the first information is associated with the synchronous transmission of a plurality of PDUs, the synchronous transmission of the plurality of PDUs may be understood as synchronous transmission among the plurality of PDUs. In the embodiments of the present application, the synchronous transmission of a plurality of PDUs may also be understood as synchronous transmission of the plurality of PDUs together with other PDUs. Here, other PDUs may be understood as PDUs other than those associated with the first information, and/or other PDUs may be PDUs with synchronization requirements.

In other implementations, if the first information is associated with the coordinated transmission of a single PDU, the coordinated transmission associated with the single PDU may be understood as coordinated transmission of the single PDU together with other PDUs. Optionally, the aforementioned single PDU may be any PDU or a specific PDU. If the first information is associated with the coordinated transmission of a plurality of PDUs, the coordinated transmission of the plurality of PDUs may be understood as coordinated transmission among the plurality of PDUs. In the embodiments of the present application, the coordinated transmission of a plurality of PDUs may also be understood as coordinated transmission of the plurality of PDUs together with other PDUs. Here, other PDUs may be understood as PDUs other than those associated with the first information, and/or other PDUs may be PDUs with coordination requirements.

When an object is an SDU, in some implementations, if the first information is associated with the synchronous transmission of a single SDU, the synchronous transmission of the single SDU may be understood as synchronous transmission of the single SDU together with other SDUs. Optionally, the aforementioned single SDU may be any SDU or a specific SDU. If the first information is associated with the synchronous transmission of a plurality of SDUs, the synchronous transmission of the plurality of SDUs may be understood as synchronous transmission among the plurality of SDUs. In the embodiments of the present application, the synchronous transmission of a plurality of SDUs may also be understood as synchronous transmission of the plurality of SDUs together with other SDUs. Here, other SDUs may be understood as SDUs other than those associated with the first information, and/or other SDUs may be SDUs with synchronization requirements.

In other implementations, if the first information is associated with the coordinated transmission of a single SDU, the coordinated transmission associated with the single SDU may be understood as coordinated transmission of the single SDU together with other SDUs. Optionally, the aforementioned single SDU may be any SDU or a specific SDU. If the first information is associated with the coordinated transmission of a plurality of SDUs, the coordinated transmission of the plurality of SDUs may be understood as coordinated transmission among the plurality of SDUs. In the embodiments of the present application, the coordinated transmission of a plurality of SDUs may also be understood as coordinated transmission of the plurality of SDUs together with other SDUs. Here, other SDUs may be understood as SDUs other than those associated with the first information, and/or other SDUs may be SDUs with coordination requirements.

When an object is data, in some implementations, if the first information is associated with the synchronous transmission of a single piece of data, the synchronous transmission of the single piece of data may be understood as synchronous transmission of the single piece of data together with other data. Optionally, the aforementioned single piece of data may be any piece of data or a specific piece of data. If the first information is associated with the synchronous transmission of a plurality of pieces of data, the synchronous transmission of the plurality of pieces of data may be understood as synchronous transmission among the plurality of pieces of data. In the embodiments of the present application, the synchronous transmission of the plurality of pieces of data may also be understood as synchronous transmission of the plurality of pieces of data together with other data. Here, other data may be understood as data other than that associated with the first information, and/or other data may be data with synchronization requirements.

In other implementations, if the first information is associated with the coordinated transmission of a single piece of data, the coordinated transmission associated with the single piece of data may be understood as coordinated transmission of the single piece of data together with other data. Optionally, the aforementioned single piece of data may be any piece of data or a specific piece of data. If the first information is associated with the coordinated transmission of a plurality of pieces of data, the coordinated transmission of the plurality of pieces of data may be understood as coordinated transmission among the plurality of pieces of data. In the embodiments of the present application, the coordinated transmission of a plurality of pieces of data may also be understood as coordinated transmission of the plurality of pieces of data together with other data. Here, other data may be understood as data other than that associated with the first information, and/or other data may be data with coordination requirements.

If an object is a data burst, in some implementations, if the first information is associated with the synchronous transmission of a single data burst, the synchronous transmission of the single data burst may be understood as synchronous transmission of the single data burst together with other data bursts. Optionally, the aforementioned single data burst may be any data burst or a specific data burst. If the first information is associated with the synchronous transmission of a plurality of data bursts, the synchronous transmission of the plurality of data bursts may be understood as synchronous transmission among the plurality of data bursts. In the embodiments of the present application, the synchronous transmission of a plurality of data bursts may also be understood as synchronous transmission of the plurality of data bursts together with other data bursts. Here, other data bursts may be understood as data bursts other than those associated with the first information, and/or other data bursts may be data bursts with synchronization requirements.

In other implementations, if the first information is associated with the coordinated transmission of a single data burst, the coordinated transmission associated with the single data burst may be understood as coordinated transmission of the single data burst together with other data bursts. Optionally, the aforementioned single data burst may be any data burst or a specific data burst. If the first information is associated with the coordinated transmission of a plurality of data bursts, the coordinated transmission of the plurality of data bursts may be understood as coordinated transmission among the plurality of data bursts. In the embodiments of the present application, the coordinated transmission of a plurality of data bursts may also be understood as coordinated transmission between a plurality of data bursts together with other data bursts. Here, other data bursts may be understood as data bursts other than those associated with the first information, and/or other data bursts may be data bursts with coordination requirements.

The objects in the embodiments of the present application have been introduced above. The first information involved in the embodiments of the present application will be introduced below.

In some implementations, the first information is used to indicate one or more of the following: a synchronous or coordinated transmission requirement exists for the at least one object; a parameter for synchronous or coordinated transmission of at least one object; an identifier corresponding to at least one object; a type corresponding to at least one object; whether at least one object corresponds to a target identifier; whether at least one object corresponds to a target type; a requirement for synchronous or coordinated transmission between at least two objects; a parameter for synchronous or coordinated transmission between at least two objects; synchronous or coordinated transmission between at least two objects needs to be performed; whether at least two objects correspond to the same identifier; whether at least two objects correspond to the same type; whether at least two objects correspond to a target identifier; whether at least two objects correspond to a target type; an association relationship between at least two objects; or a binding relationship between at least two objects.

If the first information is used to indicate that a synchronous or coordinated transmission requirement exists for at least one object, this can be alternatively stated as that the first information is used to indicate that synchronous or coordinated transmission of one or more objects needs to be performed.

If the first information is used to indicate a parameter for synchronous or coordinated transmission of at least one object, it can be understood as that the first information carries the above parameter or carries indication information for the above parameter (e.g., an index corresponding to the parameter). In the embodiments of the present application, the aforementioned parameter is not limited. For example, the parameter may include one or more of the following: a transmission delay, a transmitting time, an arrival time, a processing time, a decoding time, an encoding time, or a delivery time.

If the first information is used to indicate the identifier corresponding to at least one object, the identifier is not limited in the embodiments of the present application. For example, if an object is a terminal device, the identifier can be a terminal device identifier. As another example, if an object is a QoS flow, the identifier is a QoS flow identifier (QFI). As another example, if an object is data, the identifier is a data identifier. As another example, if an object is a PDU session, the identifier can be a PDU session identifier. As another example, if an object is a bearer, the identifier is a bearer identifier. As another example, if an object is a data flow, the identifier is a data flow identifier.

If the first information is used to indicate a flag corresponding to at least one object, the flag is not limited in the embodiments of the present application. For example, if an object is a terminal device, the flag can be an indication/flag identifying whether the terminal device supports coordinated or synchronous transmission, or the flag can be used to identify which type of coordinated or synchronous transmission the terminal device supports, or the flag can be used to identify whether the terminal device has the capability to support coordinated or synchronous transmission.

If the first information is used to indicate the type corresponding to at least one object, in some implementations, this type can be a service type. For example, the first information can be used to indicate that the type of at least one object is an XR service or a CG service. In other implementations, this type can include a synchronous transmission type and/or a coordinated transmission type. For example, the first information can be used to indicate that the type of at least one object is a synchronous transmission service or a coordinated transmission service.

If the first information is used to indicate whether at least one object corresponds to a target identifier (also referred to as a “specific identifier”), this target identifier can be used to identify an object for which a synchronous or coordinated transmission requirement exists, or in other words, the target identifier is used to identify an object to be subjected to synchronous or coordinated transmission.

In the embodiments of the present application, the generation method of the target identifier is not limited. For example, the target identifier can be predefined by a protocol. As another example, the target identifier can be configured by a network device. As another example, the target identifier can be pre-configured. As another example, the target identifier can be written into a SIM card, or as another example, the target identifier can be stored in a SIM card.

If the first information is used to indicate whether at least one object corresponds to a target type, this target type can be used to identify a class of objects for which a synchronous or coordinated transmission requirement exists, or in other words, the target type is the type of the objects to be subjected to synchronous or coordinated transmission.

If the first information is used to indicate a requirement for synchronous or coordinated transmission between at least two objects, this can be rephrased as that the first information is used to indicate that synchronous or coordinated transmission between at least two objects needs to be performed, or in other words, the first information is used to indicate performing synchronous or coordinated transmission between at least two objects.

If the first information is used to indicate the parameter for synchronous or coordinated transmission between at least two objects, it can be understood as that the first information carries the above parameter or carries indication information for the above parameter (e.g., an index corresponding to the parameter). In the embodiments of the present application, the aforementioned parameter is not limited. For example, the parameter may include a transmission delay, a transmitting time, an arrival time, a processing time, a decoding time, an encoding time, or a delivery time.

If the first information is used to indicate whether at least two objects correspond to the same identifier, and when the at least two objects correspond to the same identifier, then synchronous or coordinated transmission between the at least two objects needs to be performed. Conversely, if the at least two objects correspond to different identifiers, then synchronous or coordinated transmission between the at least two objects does not need to be performed.

This identifier is not limited in the embodiments of the present application. For example, the identifier can be used to identify the objects that require synchronous or coordinated transmission. As another example, the identifier can be used to identify the service type (e.g., XR service) corresponding to the synchronous or coordinated transmission between the at least two objects. As another example, the identifier can be used to identify that the at least two objects correspond to one type (or a class) of synchronous or coordinated transmission. As another example, the identifier can be used to indicate that the at least two objects require synchronous or coordinated transmission or used to indicate performing synchronous or coordinated transmission between the at least two objects.

If the first information is used to indicate whether at least two objects correspond to the same flag, and when the at least two objects correspond to the same flag, then synchronous or coordinated transmission between the at least two objects needs to be performed, or the synchronous or coordinated transmission corresponding to the flag needs to be performed. Conversely, if the at least two objects correspond to different flags, then synchronous or coordinated transmission between the at least two objects does not need to be performed, or the synchronous or coordinated transmission corresponding to the flag does not need to be performed between the at least two objects.

This flag is not limited in the embodiments of the present application. For example, the flag can be used to identify a flag that requires synchronous or coordinated transmission. As another example, the flag can be used to identify the service type (e.g., XR service) corresponding to the synchronous or coordinated transmission between the at least two objects. As another example, the flag can be used to identify that at least two objects correspond to one type or a class of synchronous or coordinated transmission. As another example, the identifier can be used to indicate that the at least two objects require synchronous or coordinated transmission or used to indicate performing synchronous or coordinated transmission between the at least two objects. As another example, the flag can be used to identify which type of synchronous or coordinated transmission the at least two objects correspond to.

In the case where the first information is used to indicate whether at least two objects correspond to the same type, if the at least two objects correspond to the same type, then synchronous or coordinated transmission between the at least two objects needs to be performed. Conversely, if the at least two objects correspond to different types, then synchronous or coordinated transmission between the at least two objects does not need to be performed.

This type is not limited in the embodiments of the present application. For example, the type can be the type of objects that require synchronous or coordinated transmission. As another example, the type can be the service type (e.g., XR service) corresponding to the synchronous or coordinated transmission between the at least two objects. As another example, the type can be the transmission type corresponding to the synchronous or coordinated transmission between the at least two objects.

If the first information is used to indicate whether at least two objects correspond to a target identifier, this target identifier can be used to identify objects for which a synchronous or coordinated transmission requirement exists, or in other words, the target identifier is used to identify objects to be subjected to synchronous or coordinated transmission. It should be understood that reference may be made to the foregoing description for the introduction of the target identifier, which will not be repeated here for the sake of brevity.

If the first information is used to indicate whether at least two objects correspond to a target type, this target type can be a type indicating a synchronous or coordinated transmission requirement, or in other words, the target type is the type of the object to be subjected to synchronous or coordinated transmission. It should be understood that reference may be made to the foregoing description for the introduction of the target identifier, which will not be repeated here for the sake of brevity.

If the first information is used to indicate an association relationship between at least two objects, the association relationship is used to indicate that a synchronous or coordinated transmission requirement exists between the at least two objects. In some scenarios, the aforementioned association relationship can be replaced by a binding relationship, which is to say, the binding relationship is used to indicate that a synchronous or coordinated transmission requirement exists between the at least two objects.

In the embodiments of the present application, when the aforementioned at least one object is a plurality of objects, the at least two objects can be at least two of the plurality of objects.

In some implementations, the aforementioned first information includes identification information, which includes one or more of the following: identification information of a target object; identification information of a first object among the at least one object; identification information of each of the at least one object; or identification information of at least two objects.

In some implementations, the identification information can include the identification information of a target object, and the target object can be part or all of the at least one object.

In some implementations, the identification information can include the identification information of a first object among the at least one object. The first object can be a certain object among the at least one object, or in other words, the first object can be a specific object among the at least one object. In the embodiments of the present application, the identification information can also include the identification information of each of the at least one object.

In some implementations, the identification information can include the identification information of a first object among the at least one object. The identification information of the first object is the identification information corresponding to the current object, or the identification information corresponding to an object that has a synchronous or coordinated transmission association with the current object.

In some implementations, the identification information can include the identification information of at least two objects, or in other words, the identification information is used to identify at least two objects. When the at least one object includes a plurality of objects, the at least two objects belong to the plurality of objects.

In some implementations, the identification information can include the identification information of at least two objects. The identification information of the at least two objects is the identification information of objects having a coordinated or synchronous transmission association, or the identification information of the at least two objects is the corresponding identification information of objects, including the current object, that have a synchronous or coordinated transmission association, or the identification information corresponding to objects that have a synchronous or coordinated transmission association with the current object.

In the embodiments of the present application, the method for the second device to obtain the first information is not limited. In some implementations, the first information may be delivered from a first protocol layer of the second device to a second protocol layer of the second device, where the first protocol layer is an upper layer relative to the second protocol layer. As another example, the first information can be transmitted through a data packet delivered from the first protocol layer to the second protocol layer of the second device, where the header or payload of the data packet carries the first information. As another example, the first information can be delivered through inter-layer interaction information between the first protocol layer and the second protocol layer of the second device. In other implementations, the first information can be transmitted by a core network device to the second device. For example, the core network device can carry the first information in a NAS message transmitted to the second device. In the embodiments of the present application, the process by which the second device obtains the first information may be specified based on the internal implementation of the second device. Optionally, the acquisition of the first information by the second device may rely on auxiliary information provided by the core network device.

The first information in the embodiments of the present application has been introduced above. The triggering methods for the first information in the embodiments of the present application will be introduced below.

In some implementations, the first information is triggered based on one or more of the following: a period, a first event, a request from the first device, an enabling indication, a capability of the second device that is associated with the first information, whether the first device has obtained the first information, or whether the second device has available or valid first information.

If the first information is triggered based on whether the second device has available or valid first information, the method for determining available or valid first information is not limited in the embodiments of the present application. For example, optionally, whether available or valid first information exists may be determined based on the implementation of the second device. As another example, whether available or valid first information exists may be determined according to preset rules.

If the first information is triggered based on a period, that is to say, the first information is transmitted periodically. The period may be configured by a network device, or may be predefined, or may be pre-configured, which is not limited in the embodiments of the present application.

If the first information is triggered based on the first event, in some implementations, the first event includes one or more of the following: a first duration is exceeded; the second device is configured to transmit the first information for at least one object; the first information of at least one object has not yet been transmitted; a requirement for synchronous transmission or coordinated transmission of at least one object changes; a parameter for synchronous transmission or coordinated transmission of at least one object changes; an identifier or type for synchronous transmission or synchronous transmission of at least one object changes; an identifier or type for coordinated transmission of at least one object changes; an identifier or type for synchronous transmission between at least two objects changes; an identifier or type for coordinated transmission between at least two objects changes; a requirement for synchronous transmission or coordinated transmission between at least two objects changes; a parameter for synchronous transmission or coordinated transmission between at least two objects changes; a change in a requirement for synchronous transmission of at least one object is greater than or equal to a first change threshold; a change in a requirement for the coordinated transmission of at least one object is greater than or equal to a second change threshold; a change in a parameter for the synchronous transmission of at least one object is greater than or equal to a third change threshold; a change in a parameter for coordinated transmission of at least one object is greater than or equal to a fourth change threshold; a change in a parameter for synchronous transmission between at least two objects is greater than or equal to a fifth change threshold; a change in a parameter for coordinated transmission between at least two objects is greater than or equal to a sixth change threshold; a change in a requirement for synchronous transmission between at least two objects is greater than or equal to a seventh change threshold; a change in a requirement for coordinated transmission between at least two objects is greater than or equal to an eighth change threshold.

In some implementations, the first event may include exceeding the first duration, or in other words, the first event may include falling outside the first duration. The first duration is a period during which the transmission of the first information is prohibited or not allowed, or in other words, the first duration is a period during which the first information is not transmitted. Correspondingly, the first event can be alternatively defined as that the first information associated with synchronous transmission or coordinated transmission of at least one object has not been transmitted for a period exceeding the first duration.

In the embodiments of the present application, the first duration may be associated with at least one object. That is, the configuration granularity and/or usage granularity of the first duration may be one object among the at least one object. The usage granularity here may be interpreted as the object to which the use of the first duration is directed.

In the embodiments of the present application, the configuration granularity of the first duration may be interpreted as configuring the first duration for each object among the at least one object, or configuring the first duration for the at least one object as a whole.

In the embodiments of the present application, the usage granularity of the first duration may be interpreted as applying the first duration to each object among the at least one object, or applying the first duration to the at least one object as a whole.

Furthermore, in the embodiments of the present application, the configuration granularity of the first duration and the usage granularity of the first duration may be identical. That is, the object associated with the configuration is the same as the object for which the first duration is used, which helps to simplify the complexity of configuring and using the first duration. Alternatively, the configuration granularity of the first duration and the usage granularity of the first duration may be different. That is, the object associated with the configuration is different from the object for which the first duration is used, which helps to improve the flexibility of configuring and using the first duration.

In some implementations, the first duration may be determined based on a first timer. Correspondingly, the first event includes that the first timer expires and/or that the first timer is not running.

In the embodiments of the present application, that the first duration is determined based on the first timer can be interpreted as that the first duration is maintained by the first timer, or in other words, the first duration is recorded by the first timer.

In some implementations, the first timer is started or restarted upon the transmission of the first information. In other words, the start or restart of the first timer is triggered by the first information, or in some implementation, by the transmission of the first information.

In some implementations, the aforementioned state of the first timer not running can be interpreted as that the information for synchronous transmission or coordinated transmission of at least one object (i.e., the first information) has not been transmitted, thereby resulting in the first timer not running.

In some implementations, the aforementioned expiration of the first timer can be interpreted as the elapsing of the duration during which the transmission of the first information is prohibited (or not allowed), at which point the second device can retransmit the first information.

In some implementations, the first device and the second device may each maintain a first timer. In this case, the second device may determine the time to transmit the first information based on its first timer, and the first device may determine the time to receive the first information based on its first timer. This aligns the understanding of the transmission process of the first information between the first and second devices, thereby helping to improve the probability of successful transmission of the first information. Of course, in some embodiments of the present application, only one of the first device and the second device maintains the first timer.

In some implementations, the first timer may be configured by a network device, or the first timer may be predefined by a protocol. Of course, in some embodiments of the present application, the first timer may be pre-configured.

In some implementations, the first event may include that the second device is configured to transmit the first information of at least one object. That is, the first event may include that the second device is configured to report the first information of at least one object.

In some implementations, the first event may include that the first information of at least one object has not been transmitted yet, that is to say, the second device has not yet reported the first information of at least one object.

In some implementations, the first event may include that the requirement for synchronous transmission or coordinated transmission of at least one object changes. If the requirement for synchronous transmission changes, the change in the requirement for synchronous transmission of the at least one object may include one or more of the following: the at least one object no longer requires synchronous transmission; a parameter for the synchronous transmission of the at least one object changes; other objects undergoing synchronous transmission together with the at least one object change; or a parameter for synchronous transmission of other objects undergoing synchronous transmission with the at least one object changes. The change in a parameter for synchronous transmission is further described below.

If the requirement for coordinated transmission changes, the change in the requirement for coordinated transmission of the at least one object may include one or more of the following: the at least one object no longer requires coordinated transmission; a parameter for coordinated transmission of the at least one object changes; other objects undergoing coordinated transmission together with the at least one object change; or a parameter for coordinated transmission of other objects undergoing coordinated transmission together with the at least one object changes. The change in a parameter for coordinated transmission is further described below.

In some implementations, the first event may include that a parameter for the synchronous transmission or coordinated transmission of the at least one object changes. If the parameter for synchronous transmission includes the latency, and the latency of the at least one object changes from 5 seconds to 6 seconds, then the first event occurs. If the parameter for coordinated transmission includes the latency, and assuming that, before the parameter changes, the parameter for coordinated transmission of the at least one object indicates that the transmission of the at least one object is to be completed within 5 seconds, and then when it changes to indicate that the transmission is to be completed within 6 seconds, the first event occurs.

In some implementations, the first event may include that a parameter for synchronous transmission or coordinated transmission of at least one object changes. If the parameter for synchronous transmission includes latency, then when the latency of a certain object among the at least one object changes from 5 seconds to 6 seconds, the first event occurs.

In some implementations, the first event may include that a parameter for synchronous transmission or coordinated transmission of at least one object and that the change exceeds a threshold. If the parameter for synchronous transmission include latency, the latency of a certain object among the at least one object changes from 5 seconds to 8 seconds, and a first change threshold is 2, then the first event occurs.

In some implementations, the first event may include that a parameter for synchronous transmission or coordinated transmission of at least one object changes, and that a first timer expires. The first timer may be directed to the at least one object or a specific object among the at least one object. If the parameter for synchronous transmission includes latency, then when the latency of a certain object changes from 5 seconds to 8 seconds and the first timer directed to that object expires, the first event occurs.

In some implementations, the first event may include: that a parameter for synchronous transmission or coordinated transmission of at least one object changes, that the change exceeds a threshold, and that a first timer expires. The first timer may be directed to the at least one object or a specific object among the at least one object. If the parameter for synchronous transmission includes latency, the latency of a certain object changes from 5 seconds to 8 seconds, a first change threshold is 2, and the first timer directed to that object expires, then the first event occurs.

In some implementations, the first event may include that an identifier or type for synchronous transmission of at least one object changes. The change in the identifier for synchronous transmission of at least one object can be interpreted as a change in the requirement and/or parameter for synchronous transmission. If the requirement for synchronous transmission changes, for example, from requiring synchronous transmission of at least one object to not requiring it, then the first event occurs. If the type for synchronous transmission changes, for example, the at least one object changes from type 1 to type 2, then the first event occurs.

In some implementations, the first event may include that an identifier or type for coordinated transmission of at least one object changes. The change in the identifier for coordinated transmission can be interpreted as a change in the requirement and/or parameter for coordinated transmission of the at least one object. If the requirement for coordinated transmission changes, for example, from requiring coordinated transmission of at least one object to not requiring it, then the first event occurs. If the type for coordinated transmission changes, for example, the at least one object changes from type 1 to type 2, then the first event occurs.

In some implementations, the first event may include that an identifier or type for synchronous transmission between at least two objects changes. The change in the identifier for synchronous transmission can be interpreted as a change in the requirement and/or parameter for synchronous transmission between the at least two objects. If the requirement for synchronous transmission changes, for example, from requiring synchronous transmission between at least two objects to not requiring it, then the first event occurs. If the type for synchronous transmission changes, for example, the synchronous transmission between at least two objects changes from type 1 to type 2, then the first event occurs.

In some implementations, the first event may include that an identifier or type for coordinated transmission between at least two objects changes. The change in the identifier for coordinated transmission can be interpreted as a change in the requirement and/or parameter for coordinated transmission between the at least two objects. If the requirement for coordinated transmission changes, for example, from requiring coordinated transmission between at least two objects to not requiring it, then the first event occurs. If the type for coordinated transmission changes, for example, the coordinated transmission between at least two objects changes from type 1 to type 2, then the first event occurs.

In some implementations, the first event may include that a requirement for synchronous transmission or coordinated transmission between at least two objects changes. If the requirement for synchronous transmission between at least two objects changes from synchronous transmission requirement 1 to synchronous transmission requirement 2, then the first event occurs. If the requirement for coordinated transmission between at least two objects changes from coordinated transmission requirement 1 to coordinated transmission requirement 2, then the first event occurs.

If the requirement for synchronous transmission between at least two objects changes from involving object 1 and object 2 to involving object 2 and object 3, then the first event occurs. If the requirement for coordinated transmission between at least two objects changes from involving object 1 and object 2 to involving object 2 and object 3, then the first event occurs.

In some implementations, the first event may include that a requirement for synchronous transmission or coordinated transmission between at least two objects changes, and that a first timer expires. The first timer may be directed to the at least two objects or a specific object among the at least two objects.

In some implementations, the first event may include that a parameter for synchronous transmission or coordinated transmission between at least two objects changes. Regarding the parameter for synchronous transmission between at least two objects, the first event may include a change in this parameter from parameter 1 to parameter 2, and then the first event occurs. Regarding the parameter for coordinated transmission between at least two objects, the first event may include a change in this parameter from parameter 1 to parameter 2, and then the first event occurs.

In some implementations, the first event may include that a parameter for synchronous transmission or coordinated transmission between at least two objects changes, and that a first timer expires. The first timer may be directed to the at least two objects or a specific object among the at least two objects.

In some implementations, the first event includes that the change in the requirement for synchronous transmission or coordinated transmission of at least one object is greater than or equal to a change threshold. Regarding the requirement for synchronous transmission of at least one object, if it changes from requirement 1 to requirement 2, and the change from requirement 1to requirement 2 is greater than or equal to the change threshold, then the first event occurs. Regarding the requirement for coordinated transmission of at least one object, if it changes from requirement 1 to requirement 2, and the change from requirement 1 to requirement 2 is greater than or equal to the change threshold, then the first event occurs.

In some implementations, the first event includes that the change in parameter for the synchronous transmission of at least one object is greater than or equal to a change threshold. Regarding the parameter for synchronous transmission of at least one object, the first event may include that this parameter changes from parameter 1 to parameter 2, and that the change from parameter 1 and parameter 2 is greater than or equal to the change threshold. Regarding the parameter for coordinated transmission of at least one object, the first event may include that this parameter changes from parameter 1 to parameter 2, and that the change from parameter 1 and parameter 2 is greater than or equal to the change threshold.

In some implementations, the first event includes the magnitude of change in the synchronous transmission parameters or coordinated transmission parameters for at least one object being greater than or equal to a change threshold, and the expiration of a first timer. The first timer may be for the at least one object or for a specific object among the at least one object.

In some implementations, the first event includes that the change in the parameter for synchronous transmission or coordinated transmission between at least two objects is greater than or equal to a change threshold. In the case where the change in the parameter for synchronous transmission between at least two objects is greater than or equal to the change threshold, if the parameter changes from parameter 1 to parameter 2 and the change from parameter 1 to parameter 2 is greater than or equal to the change threshold, then the first event occurs. In the case where the change in the parameter for coordinated transmission between at least two objects is greater than or equal to the change threshold, if the parameter changes from parameter 1 to parameter 2 and the change from parameter 1 to parameter 2 is greater than or equal to the change threshold, then the first event occurs.

In some implementations, the first event includes that the change in the parameter for synchronous transmission or coordinated transmission between at least two objects is greater than or equal to a change threshold, and that a first timer expires. The first timer may be directed to the at least two objects or a specific object among the at least two objects.

In some implementations, the first event includes that the change in the requirement for synchronous transmission or coordinated transmission between at least two objects is greater than or equal to a change threshold. In the case where the change in the requirement for synchronous transmission between at least two objects is greater than or equal to the change threshold, if this requirement changes from requirement 1 to requirement 2 and the change from requirement 1 to requirement 2 is greater than or equal to the change threshold, then the first event occurs. In the case where the change in the requirement for coordinated transmission between at least two objects is greater than or equal to the change threshold, if this requirement changes from requirement 1 to requirement 2 and the change from requirement 1 to requirement 2 is greater than or equal to the change threshold, then the first event occurs.

In an embodiment of the present application, the method for defining the aforementioned change threshold is not limited. For example, the change threshold may be configured by a network device. As another example, the change threshold may be predefined by a protocol. As yet another example, the change threshold may be pre-configured.

Based on the preceding description of the first event, it is understood that in some scenarios, the first event may pertain to all of the at least one object. One example is the previously mentioned change in a parameter for coordinated transmission (or synchronous transmission) of the at least one object. Another example is the previously mentioned change in a requirement for coordinated transmission (or synchronous transmission) of the at least one object. In other scenarios, the first event may pertain to a specific object among the at least one object. One example is the previously mentioned change in a parameter for coordinated transmission (or synchronous transmission) of a specific object among the at least one object. Another example is the previously mentioned change in a requirement for coordinated transmission (or synchronous transmission) of a specific object among the at least one object.

Additionally, in the embodiments of the present application, the aforementioned first events can be used independently. Alternatively, in the embodiments of the present application, the first events can be used in combination. For example, the first event may include that the second device is configured to transmit the first information of at least one object, and that the second device has not yet transmitted the first information of the at least one object. Of course, in the embodiments of the present application, the first event may also include other conditions. For example, the first event may also include that, before the transmission of the first information, the second device has not indicated synchronous transmission or coordinated transmission of at least one object. As another example, the first event may also include that, before the transmission of the first information, the second device has not indicated information associated with synchronous transmission or coordinated transmission together with at least one object.

Furthermore, some or all of the first to eighth change thresholds mentioned above may be different. Alternatively, in the embodiments of the present application, the first to eighth change thresholds may be identical.

If the first information is triggered based on a request message transmitted by the first device, that is, before step S210, the first device transmits a request message to the second device, which is used to request the first information.

In some implementations, the aforementioned request message is used to request one or more of the following: a requirement for synchronous transmission or coordinated transmission of a target object; a parameter for synchronous transmission or coordinated transmission of the target object; an identifier or type of the target object; a requirement for synchronous transmission or coordinated transmission between at least two objects, where if the at least one object includes a plurality of objects, the plurality of objects include the at least two objects; or a parameter for synchronous transmission or coordinated transmission between at least two objects.

In some implementations, the request message is used to request the requirement for synchronous transmission or coordinated transmission of a target object, where the target object includes all or part of the at least one object. If the target object includes all of the at least one object, the request message can be interpreted as requesting the at least one object. If the target object includes part of the at least one object, the request message can be interpreted as requesting a specific object among the at least one object. Accordingly, the second device can transmit the first information associated with the synchronous or coordinated transmission of the at least one object to the first device.

In some implementations, the request message is used to request a parameter for synchronous transmission or coordinated transmission of a target object, where the target object includes all or part of the at least one object. If the target object includes all of the at least one object, the request message can be interpreted as requesting the parameter for synchronous transmission or coordinated transmission of all or part of the at least one object. If the target object includes part of the at least one object, the request message can be interpreted as requesting the parameter for synchronous transmission or coordinated transmission of a specific object among the at least one object. Accordingly, the second device can transmit to the first device the first information associated with the synchronous or coordinated transmission of the at least one object, and the at least one object can be interpreted as the object(s) undergoing synchronous or coordinated transmission together with the target object.

In some implementations, the aforementioned request message includes at least one of the following: identification information of object(s) requested in the request message; a first duration associated with the first information; a reporting period for the first information; a change threshold for a requirement for synchronous transmission or coordinated transmission; a change threshold for a transmission for synchronous transmission or coordinated transmission; or a first timer configuration and the content of the request message.

In some implementations, the aforementioned request message may include identification information of the requested object(s). The identifier of a requested object can be the identifier of the target object. If the target object is at least one object, the aforementioned identifier of the requested object can be the identifier of the at least one object.

In some implementations, the aforementioned request message may include the first duration associated with the first information. References may be made to the foregoing description for the induction related to the first duration.

In this scenario, the inclusion of the first duration in the request message can be interpreted as the first device configuring the first duration for the second device via the request message. In other words, the request message carries the configuration information of the first duration, which helps to simplify the configuration process of the first duration. Of course, in the embodiments of the present application, the aforementioned configuration information of the first duration can also be transmitted separately instead of being carried in the request message.

In some implementations, the aforementioned request message may include the reporting period of the first information. In other words, the request message is used to configure the transmission period of the first information for the second device, which helps to simplify the process of configuring the transmission of the first information. Of course, in an embodiment of the present application, the aforementioned configuration information for configuring the transmission period of the first information can also be transmitted separately instead of being carried in the request message.

In some implementations, the aforementioned request message may include the change threshold for the requirement for synchronous transmission or coordinated transmission. The change threshold can be the one mentioned in the preceding description of the first event, for which details can be found in the above description.

In some implementations, the aforementioned request message may include the change threshold for the parameter for synchronous transmission or coordinated transmission. The change threshold can be the one mentioned in the preceding description of the first event, for which details can be found in the above description.

In some implementations, the aforementioned request message may include the content of the request message. The content of the request message may include one or more of the following: an identifier corresponding to the at least one object, the type for synchronous or coordinated transmission of the at least one object, the parameters for synchronous or coordinated transmission of the at least one object, or the requirement for synchronous or coordinated transmission of the at least one object.

In the embodiments of the present application, the method for transmitting the request message is not limited. For example, the request message may be carried in one or more of the following: system information, a paging message, an RRC message, uplink control information (UCI), a medium access control control element (MAC CE) (e.g., a downlink MAC CE), a non-access stratum (NAS) message, or other configuration (otherconfig).

In some implementations, the first information may be triggered based on an enable indication. Accordingly, the enable indication may also be referred to as a trigger indication. The enable indication is used to enable the second device to transmit the first information, or in other words, the trigger indication is used to trigger the second device to transmit the first information.

In the embodiments of the present application, the device that transmits the enable indication is not limited. For example, the enable indication may be triggered by an access network device, or it may be triggered by a core network device.

In some implementations, the first information may be triggered based on the capability of the second device, where the capability of the second device is associated with the synchronous transmission or coordinated transmission of at least one object. For example, the capability of the second device may be used to indicate whether the second device has the capability supporting the synchronous transmission or coordinated transmission of the at least one object.

Accordingly, the triggering of the first information based on the capability of the second device can be interpreted as follows: if the second device possesses this capability, it can trigger the first information. Conversely, if the second device does not possess this capability, it may not trigger the first information.

In some implementations, the first information may be triggered based on whether the first device has obtained the first information. For example, if the first device has obtained the first information, it can trigger the first information. Conversely, if the first device has not obtained the first information, it may not trigger the first information.

In some implementations, whether the first device has obtained the first information may depend on whether a first protocol layer of the first device has delivered the first information to a second protocol layer of the first device, where the first protocol layer is an upper layer relative to the second protocol layer. That is, if the first protocol layer has delivered the first information to the second protocol layer, it is considered that the first device has obtained the first information, and in this case, the first device can trigger the first information. Conversely, if the first protocol layer has not delivered the first information to the second protocol layer, it is considered that the first device has not obtained the first information, and in this case, the first device may not trigger the first information.

In the embodiments of the present application, the method for delivering the first information between the first protocol layer and the second protocol layer is not limited. For example, the first information may be encapsulated in a packet header.

In some other implementations, whether the first device has obtained the first information may depend on whether a core network device has transmitted the first information to the first device. That is, if the core network device has transmitted the first information to the first device, it is considered that the first device has obtained the first information, and in this case, the first device can trigger the first information. Conversely, if the core network device has not transmitted the first information to the first device, it is considered that the first device has not obtained the first information, and in this case, the first device may not trigger the first information.

In the embodiments of the present application, the method for transmitting the first information between the core network device and the first device is not limited. For example, the first information may be encapsulated in a NAS message.

In some implementations, the first information may be triggered based on whether the first device has available or valid first information. In other words, the triggering of the first information may be determined based on whether the first device has available or valid first information. For example, if the first device has available or valid first information, the second device may not trigger the first information, so as to reduce the overhead of transmitting the first information. As another example, if the first device does not have available or valid first information, the second device can trigger the first information.

In the embodiments of the present application, whether the first device has available or valid first information can be notified by the first device to the second device. For example, if the first device does not have available or valid first information, the first device can transmit an indication message to the second device to indicate that the first device does not have available or valid first information. As another example, if the first device has available or valid first information, the first device can transmit an indication message to the second device to indicate that the first device has available or valid first information. Of course, in the embodiments of the present application, the indication message may be transmitted only when the first device does not have available or valid first information, and the indication message may not be transmitted when the first device has available or valid first information. Alternatively, the indication message may be transmitted only when the first device has available or valid first information, and the indication message may not be transmitted when the first device does not have available or valid first information.

The preceding sections have described the methods for triggering the first information in the embodiments of the present application. The following sections will describe the methods for transmitting the first information in the embodiment of the present application, with reference to transmission method 1 and transmission method 2.

Transmission Method 1: the first information is carried in a control plane message, or in other words, the first information is transmitted via control plane signaling.

In some implementations, the control plane information includes an RRC message. For example, the RRC message may be UE assistance information (UAI), and the first information can be carried in the UAI. That is, new UAI can be introduced to report content and to carry the first information. For example, a new IE can be introduced to carry the first information to indicate the requirement for synchronous transmission or coordinated transmission between QoS flows.

In other implementations, the control plane information may include a NAS message. For example, the NAS message may be an UL information transfer (ULinformationTransfer) message.

In some implementations, the first information is carried in sub-information of the control plane information, and the sub-information carries the identification information. Of course, in the embodiments of the present application, the first information can be carried in the control plane information, and the control plane information carries the identification information. Herein, for the identification information, reference may be made to the foregoing description.

If PDU-SessionUL-TrafficInfo is carried in UL-TrafficInfo, and a QoS-FlowUL-TrafficInfo IE is carried in PDU-SessionUL-TrafficInfo, the aforementioned information and sub-information may carry an identifier QFI, which is used to identify the at least one object associated with the first information, i.e., at least one QoS flow.

Accordingly, carrying the first information in the control plane information can be interpreted as carrying the first information in the UL-TrafficInfo, and carrying the first information in sub-information of the control plane information can be interpreted as carrying the first information in the PDU-SessionUL-TrafficInfo and/or the QoS-FlowUL-TrafficInfo IE.

In some implementations, the first device is an access network device or a core network device, and the second device is a terminal device. The core network device may be one or more of an AF, PCF, SMF, or UPF, which is not limited in the embodiments of the present application.

In the embodiments of the present application, since the terminal device can typically more easily obtain the requirement for synchronous transmission or coordinated transmission of at least one object, transmitting the first information to the network device by the terminal device helps to improve the accuracy of the first information. Furthermore, in the embodiments of the present application, if an access network device can obtain the first information, the access network device can assist in implementing the synchronous or coordinated transmission of the at least one object on the access network side. Additionally, in the embodiments of the present application, if a core network device can obtain the first information, the core network device can assist in implementing the synchronous or coordinated transmission of the at least one object on the core network side.

The preceding sections have described a scheme for transmitting the first information between a terminal device and a network device (e.g., a core network device or an access network device). The transmission scheme for the first information described below can be used for transmission between network devices. In some implementations, it may be applied to transmit the first information between a core network device and an access network device. For example, the first device is an access network device, and the second device is a core network device. In other implementations, both the first device and the second device can be core network devices. For example, the first information may be transmitted from a policy control function (PCF) or an application function (AF) to a session management function (SMF). As another example, the first information may be carried by the PCF or AF via a time sensitive communication assistance container (TSCAC).

In the embodiments of the present application, if a core network device can learn that the synchronous transmission or coordinated transmission of at least one object is required, the core network device can transmit the first information to an access network device, which helps reduce the increase in air interface signaling overhead caused by communication between the terminal device and the access network device.

In some implementations, the aforementioned control plane information includes one or more of the following: QoS configuration information, information carrying QoS parameters, or time sensitive communication assistance information (TSCAI).

In the embodiments of the present application, the specific method for transmitting the first information via control plane information is not limited. For example, the first information may be carried in the control plane information. If the control plane information includes TSCAI, the first information can be carried in TSCAI. If the control plane information includes information carrying QoS parameters, the first information can be carried in that information. If the control plane information includes QoS configuration information (QoS profile information), the first information can be carried in the QoS configuration information.

In another example, transmitting the first information via control plane information may include transmitting the first information together with the control plane information. If the control plane information includes TSCAI, the first information is transmitted together with TSCAI. If the control plane information includes information carrying QoS parameters, the first information is transmitted together with that information. If the control plane information includes the QoS configuration information, the first information is transmitted together with the QoS configuration information.

In the embodiments of the present application, since TSCAI is indicated based on a QoS flow, adding the first information associated with the QoS flow corresponding to the TSCAI helps to make the transmission scheme for the first information compatible with the communication process of known communication systems.

Transmission Method 2: The first information is carried in user plane information, or the first information is transmitted via user plane information.

In some implementations, the user plane information includes one or more of the following: a first data packet, a service data adaptation protocol (SDAP) protocol data unit (PDU), a packet data convergence protocol (PDCP) PDU, a medium access control control element (MAC CE), a MAC PDU, or uplink control information (UCI). The SDAP PDU may include an SDAP data PDU and an SDAP control PDU. Furthermore, the SDAP control PDU may be an End-Marker Control PDU.

In some implementations, the first information is carried in the header of the user plane information, or the first information is carried in the payload of the user plane information.

In some implementations, to reduce the complexity for the first device to receive user plane information, the user plane information can carry second information. The second information is used to indicate that the user plane information carries the first information, or alternatively, the second information is used to indicate that the user plane information is specific information that carries the first information.

For example, the user plane information may be an SDAP PDU, and the SDAP PDU can carry the second information used to indicate that the SDAP PDU is a PDU carrying the first information.

In another example, the user plane information may be a PDCP PDU, and the PDCP PDU can carry the second information used to indicate that the PDCP PDU is a PDU carrying the first information.

In the embodiments of the present application, the method for carrying the second information in the user plane information is not limited. In some implementations, the second information may be carried in the header. In other implementations, the second information may be carried in the payload.

In some implementations, the aforementioned second information may be a PDU type, which is used to indicate whether the SDAP PDU carries the first information. For example, if the PDU type is 00, it can indicate that the SDAP PDU carries the first information. In another example, if the PDU type is 11, it can indicate that the SDAP PDU does not carry the first information. This will be described below with reference to FIG. 5.

In the embodiments of the present application, the number of bits occupied by the second information is not limited. For example, the second information can occupy only one bit. In another example, the second information can occupy multiple bits.

In some implementations, the at least one object includes at least one QoS flow, and the SDAP PDU includes a first field, which is used to carry one or more of the following: an identifier or type of the at least one QoS flow; an indication of whether the QoS flow corresponding to the first field is a QoS flow associated with the first information; a requirement for synchronous transmission or coordinated transmission of the at least one QoS flow; a parameter for synchronous transmission or coordinated transmission of the at least one QoS flow; an identifier of a QoS flow associated with the first information; an identifier of a QoS flow for which a synchronous or coordinated transmission requirement exists, where the QoS flow for which the synchronous or coordinated transmission requirement exists includes the at least one QoS flow; or an identifier of a QoS flow for which synchronous or coordinated transmission parameters exist, where the QoS flow for which synchronous or coordinated transmission parameters exist includes the at least one QoS flow.

In the embodiments of the present application, the aforementioned first field is not limited. For example, the first field may be a reserved field (denoted by “R”) or an extended field (denoted by “E”) in the SDAP PDU. That is, for an SDAP PDU that carries the first information in a reserved field, the first device cannot ignore the information in that field. In this case, this SDAP PDU can be understood as a different type of SDAP PDU from a conventional one, or alternatively, an SDAP PDU carrying the first information can be considered a newly introduced SDAP PDU.

Of course, in the embodiments of the present application, that the first device cannot ignore the information in the reserved or extended field may be determined based on one or more of the following conditions. For example, the condition may be that the second device supports the reporting of the first information, or that the second device has the capability to report the first information. In this case, when the aforementioned condition is met, the first device cannot ignore the information in the reserved or extended field, which helps to increase the probability of successful transmission of the first information. In another example, the condition may be that the first device configures the second device to transmit the first information. In this case, when the condition is met, the first device cannot ignore the information in the reserved or extended field, which helps to increase the probability of successful transmission of the first information.

In some implementations, the enabling of the aforementioned SDAP PDU carrying the first information may be configured by a network device. That is, if the network device configures the first device to use (or enable) the aforementioned SDAP PDU, the first device can carry the first information in the reserved field of the SDAP PDU. Conversely, if the network device configures the first device not to use (or to disable) the aforementioned SDAP PDU, the first device cannot carry the first information in the reserved field of the SDAP PDU. Of course, in the embodiments of the present application, the enabling of the SDAP PDU carrying the first information may be predefined in the protocol. For example, the protocol may specify that a target device or a device of a target type can enable the SDAP PDU carrying the first information. In another example, the protocol may specify that devices other than the target device or the device of the target type cannot enable the SDAP PDU carrying the first information.

In some implementations, a target device can be understood as a device that has a synchronous or coordinated transmission requirement. Alternatively, a target device is a device that possesses the capabilities described above. Alternatively, a target device can be a device of a specific version, and the device of this version has a synchronous or coordinated transmission requirement and/or possesses the capabilities described above. Of course, in the embodiments of the present application, a target device can also be a device that has first information to be transmitted (e.g., to report the first information for the first time, or to update the first information for the first device).

In some implementations, a device of the target type can be understood as a type of devices that have a synchronous or coordinated transmission requirement. Alternatively, a device of the target type is a type of devices that possesses the capabilities described above. Alternatively, a device of the target type may be a type of devices of a specific version, and such devices have a synchronous or coordinated transmission requirement and/or possess the capabilities described above. Of course, in the embodiments of the present application, a device of the target type may be a type of devices that has first information to be transmitted (e.g., to report the first information for the first time, or to update the first information for the first device).

In some implementations, identifier information of the bearer for transmitting the at least one object may be carried in the SDAP PDU. Of course, in the embodiments of the present application, the bearer for transmitting the SDAP PDU can be used to determine the bearer for transmitting the at least one object. For example, the bearer for transmitting the SDAP PDU can be the bearer for transmitting the at least one object, as detailed in the description with reference to FIG. 7. In another example, the bearer for transmitting the at least one object can be determined based on the bearer for transmitting the SDAP PDU and a mapping relationship. The mapping relationship here is a mapping relationship between bearers for transmitting SDAP PDUs and bearers for transmitting at least one object.

In some implementations, if the first information is carried in an SDAP data PDU (e.g., RDI=1), the SDAP layer of the second device (e.g., UE) can store the updated mapping relationship and deliver it to a lower layer (e.g., the PDCP layer). The mapping relationship here is a mapping relationship between at least one object and the bearers.

For ease of understanding, the structure of the SDAP control PDU in the embodiments of the present application is described below with reference to FIGS. 3 to 5.

FIG. 3 is a schematic diagram of an SDAP control PDU according to an embodiment of the present application. As shown in FIG. 3, the first information is carried in the SDAP control PDU, and the second information is carried in the R field. The second information is used to indicate that the SDAP control PDU is a PDU carrying the first information. Correspondingly, the receiving end cannot ignore the information in the R field. Additionally, the QFI/PQFI in the first octet (Oct1) of the SDAP control PDU is the identifier of the at least one object associated with the first information.

FIG. 4 is a schematic diagram of an SDAP control PDU according to another embodiment of the present application. As shown in FIG. 4, the first information is carried in the SDAP control PDU, and the second information is carried in the E field. The second information is used to indicate that the SDAP control PDU is a PDU carrying the first information. Correspondingly, the receiving end cannot ignore the information in the E field. Additionally, the QFI/PQFI in the first octet (Oct1) of the SDAP control PDU is the identifier of the at least one object associated with the first information.

FIG. 5 is a schematic diagram of an SDAP control PDU according to another embodiment of the present application. To improve compatibility with conventional SDAP control PDUs, a PDU type can be introduced to indicate whether the first information is carried in an SDAP control PDU. As shown in FIG. 5, the PDU type can occupy two bits in the second octet (Oct2) of the SDAP control PDU. If the PDU type is 00, it indicates that the first information is carried in this SDAP control PDU. Additionally, the QFI/PQFI in the first octet (Oct1) is the identifier of the at least one object associated with the first information, and the QFI/PQFI in the second octet is the identifier of other objects undergoing synchronous or coordinated transmission together with the at least one object.

The structure of the SDAP data PDU in the embodiments of the present application is described below with reference to FIGS. 6 and 7.

Referring to FIG. 6, in the SDAP data PDU, the D/C indicator is used to indicate whether the SDAP PDU is a control PDU or a data PDU. The QFI/PQFI in the first octet (Oct1) and the associated QFI/PQFI in the second octet are identifiers of the at least one object associated with the first information. The data part of the SDAP data PDU may carry the RDI to indicate whether the uplink QoS flow to DRB mapping rule is updated. The data part may also carry the RQI to indicate whether to notify the CN NAS that the UL needs to update the mapping from SDF to QoS flow. Additionally, the data part may carry an identifier of the DRB to which the at least one object needs to be mapped.

In the embodiments of the present application, the radio bearer that carries the data or data packets associated with the at least one object may be directly indicated in the SDAP data PDU to simplify the complexity of determining the radio bearer.

Referring to FIG. 7, in the SDAP data PDU, the D/C indicator is used to indicate whether the SDAP PDU is a control PDU or a data PDU. The QFI/PQFI in the first octet (Oct1) and the associated QFI/PQFI in the second octet are identifiers of the at least one object associated with the first information. The data part of the SDAP data PDU may carry the RDI to indicate whether the uplink QoS flow to DRB mapping rule is updated. The data part may also carry the RQI to indicate whether to notify the CN NAS that the UL needs to update the mapping from SDFs to QoS flows.

Additionally, the radio bearer for transmitting the at least one object associated with the first information can be determined according to the radio bearer for transmitting the SDAP data PDU. For example, if the first information is associated with QoS flow 1 and QoS flow 2, then DRB1 is used to transmit SDAP data PDUs for both QoS flow 1 and QoS flow 2, to indicate that both QoS flow 1 and QoS flow 2 are mapped to DRB1.

Alternatively, if the first information is associated with QoS flow 1 and QoS flow 2, and QoS flow 1 is already mapped to DRB1 through other means, then DRB1 is used to transmit an SDAP data PDU for QoS flow 2 to indicate that QoS flow 2 is also mapped to DRB1.

In the embodiments of the present application, the radio bearer for transmitting the SDAP data PDU can be used to implicitly indicate the radio bearer for transmitting the at least one object associated with the first information, which helps to reuse the format of known SDAP PDUs as much as possible.

It should be noted that while the preceding description used an SDAP PDU as an example to illustrate the method for carrying the first information, in the embodiments of the present application, the first information can be carried in other PDUs, such as a PDCP PDU. For the specific carrying method, reference may be made to the foregoing description regarding the SDAP PDU, which will not be repeated below for brevity.

In some implementations, the first information is carried in the first data packet, and the first data packet satisfies one or more of the following: the first data packet corresponds to the at least one object associated with the first information; a QoS flow of the first data packet is associated with the at least one object; a PDU session of the first data packet is associated with the at least one object; a data flow to which the first data packet belongs is associated with the at least one object; or a bearer corresponding to the first data packet is associated with the at least one object.

In some implementations, if an object is a QoS flow, the condition that the first data packet corresponds to the at least one object associated with the first information can be understood as that the first data packet corresponds to the QoS flow associated with the first information. If an object is a data flow, the condition that the first data packet corresponds to the at least one object associated with the first information can be understood as that the first data packet is a packet within the data flow associated with the first information. If an object is a terminal device, the condition that the first data packet corresponds to the at least one object associated with the first information can be understood as that the first data packet is a packet of the terminal device associated with the first information. If an object is a bearer, the condition that the first data packet corresponds to the at least one object associated with the first information can be understood as that the first data packet is transmitted via the bearer associated with the first information. If an object is a PDU session, the condition that the first data packet corresponds to the at least one object associated with the first information can be understood as that the first data packet is transmitted via the PDU session associated with the first information.

In some implementations, if an object is a QoS flow, the condition that the QoS flow of the first data packet is associated with the at least one object can be understood as that the QoS flow of the first data packet is one of the at least one QoS flow. If an object is a data flow, the condition that the QoS flow of the first data packet is associated with the at least one object can be understood as that the QoS flow of the first data packet corresponds to at least one data flow. If an object is a terminal device, the condition that the QoS flow of the first data packet is associated with the at least one object can be understood as that the QoS flow of the first data packet is a QoS flow of the at least one terminal device. If an object is a bearer, the condition that the QoS flow of the first data packet is associated with the at least one object can be understood as that the QoS flow of the first data packet is transmitted via the at least one bearer. If an object is a PDU session, the condition that the QoS flow of the first data packet is associated with the at least one object can be understood as the QoS flow of the first data packet is transmitted via the PDU session associated with the first information.

In some implementations, if an object is a QoS flow, the condition that the PDU session of the first data packet is associated with the at least one object can be understood as that the PDU session of the first data packet belongs to the at least one QoS flow. If an object is a data flow, the condition that the PDU session of the first data packet is associated with the at least one object can be understood as that the PDU session of the first data packet carries the at least one data flow. If an object is a terminal device, the condition that the PDU session of the first data packet is associated with the at least one object can be understood as that the PDU session of the first data packet is a PDU session of at least one terminal device. If an object is a bearer, the condition that the PDU session of the first data packet is associated with the at least one object can be understood as that the PDU session of the first data packet is associated with at least one bearer. If an object is a PDU session, the condition that the PDU session of the first data packet is associated with the at least one object can be understood as that the PDU session of the first data packet is one of the at least one PDU session.

In some implementations, if an object is a QoS flow, the condition that the data flow to which the first data packet belongs is associated with the at least one object can be understood as that the data flow of the first data packet corresponds to the at least one QoS flow. If an object is a data flow, the condition that the data flow to which the first data packet belongs is associated with the at least one object can be understood as that the data flow of the first data packet is one of the at least one data flow. If an object is a terminal device, the condition that the data flow to which the first data packet belongs is associated with the at least one object can be understood as that the data flow of the first data packet corresponds to a PDU session of the at least one terminal device. If an object is a bearer, the condition that the data flow to which the first data packet belongs is associated with the at least one object can be understood as that the data flow of the first data packet is transmitted via the at least one bearer. If an object is a PDU session, the condition that the data flow to which the first data packet belongs is associated with the at least one object can be understood as that the data flow of the first data packet belongs to the at least one PDU session.

In some implementations, if an object is a QoS flow, the condition that the bearer corresponding to the first data packet is associated with the at least one object can be understood as that the bearer of the first data packet corresponds to the at least one QoS flow. If an object is a data flow, the condition that the bearer corresponding to the first data packet is associated with the at least one object can be understood as that the bearer of the first data packet is used to transmit the at least one data flow. If an object is a terminal device, the condition that the bearer corresponding to the first data packet is associated with the at least one object can be understood as that the bearer of the first data packet is data packets of the at least one terminal device. If an object is a bearer, the condition that the bearer corresponding to the first data packet is associated with the at least one object can be understood as that the bearer of the first data packet belongs to the at least one bearer. If an object is a PDU session, the condition that the bearer corresponding to the first data packet is associated with the at least one object can be understood as that the bearer of the first data packet corresponds to the at least one PDU session.

In some implementations, the first device is an access network device or a core network device, and the second device is a terminal device. In other implementations, the first device is an access network device, and the second device is a core network device. In yet other implementations, the first device is a core network device, and the second device is an access network device or a terminal device. For example, an access network device or a terminal device may transmit the first information to a core network device, and the synchronous or coordinated transmission of the at least one object associated with the first information is applicable to uplink transmission.

The preceding sections have described the transmission scheme for the first information in embodiments of the present application. The following sections will describe a processing scheme for the at least one object, which helps to achieve synchronous or coordinated transmission during the transmission process.

In some implementations, the QoS flows associated with the at least one object are carried via the same data radio bearer (DRB), or in other words, the QoS flows associated with the at least one object can be mapped to the same DRB. This helps to reduce the impact on certain protocol layers (e.g., PDCP, RLC, MAC layers) and lower the implementation complexity for the terminal device.

In some implementations, the QoS flows associated with the at least one object can be associated with the same DRB through RRC configuration. For example, in the SDAP configuration, a single DRB/SDAP configuration is associated with at least one object. That is, in the SDAP configuration corresponding to one DRB, at least one associated object is added to the mappedQoS-FlowsToAdd IE.

In some implementations, if a certain object among the at least one object in the aforementioned SDAP configuration is deleted, the objects (i.e., the at least one object) for which a synchronous or coordinated transmission requirement exists with that object are also deleted.

In other implementations, the QoS flows associated with the at least one object can be associated with a default DRB through RRC configuration. For example, in the SDAP configuration, the QoS flows associated with the at least one object can be associated with the default DRB. That is, in the SDAP configuration corresponding to a default DRB, the QoS flows associated with the at least one object are added to the mappedQoS-FlowsToAdd IE.

In some implementations, if a certain object among the at least one object in the aforementioned SDAP configuration is deleted, the other objects (i.e., the at least one object) that for which a synchronous or coordinated transmission requirement exists with that object are also deleted.

In other implementations, a downlink (DL) SDAP header may be used to indicate the mapping relationship between QoS flows associated with the at least one object and DRBs. For example, if the second device is a terminal device, it performs UL reflective mapping between QoS flow and DRB according to the indication in the DL SDAP header. That is to say, when the terminal device receives a DL SDAP data PDU, and its DL SDAP header carries a QFI and the RDI indicates a specific value (e.g., 1, indicating that the mapping rule between DRBs and QoS flows needs to be updated or stored), the terminal device performs the UL reflective mapping between DRBs and QoS flows, or modifies the mapping relationship between uplink QoS flows and DRBs.

In some other implementations, the QoS flows associated with the at least one object are carried via different DRBs. In other words, the QoS flows associated with the at least one object can be carried via multiple different DRBs, or mapped to multiple different bearers, which helps to reduce the impact on certain protocol layers (e.g., the SDAP layer).

In some implementations, the multiple DRBs satisfy one or more of the following: configuration parameters of at least two DRBs among the multiple DRBs match; configuration parameters of at least two DRBs are identical or similar; LCP mapping restrictions corresponding to at least two DRBs match; or LCP mapping restrictions corresponding to at least two DRBs are identical or similar. This helps to achieve synchronous or coordinated transmission of the at least one object.

In the embodiments of the present application, the condition that the configuration parameters are similar is not limited. In some implementations, each configuration parameter may include multiple sub-parameters, and correspondingly, that the multiple configuration parameters are similar can be understood as that the number of differing sub-parameters between the multiple configuration parameters is less than a threshold. In some other implementations, that the multiple configuration parameters are similar can be understood as that the difference between the multiple configuration parameters is less than a threshold.

In some implementations, if the QoS flows associated with the at least one object are carried via different DRBs, for the data associated with the at least one object, LCHs having the same LCH priority are multiplexed into to a MAC PDU, which helps to achieve coordinated or synchronous transmission of the at least one object.

In some implementations, the QoS flows associated with the at least one object are carried via the same logical channel (LCH) or logical channel group (LCG), which helps to achieve coordinated or synchronous transmission of the at least one object. Of course, in the embodiments of the present application, the QoS flows associated with the at least one object may be carried via different LCHs or LCGs.

In some implementations, if the QoS flows associated with the at least one object are carried via multiple different LCHs, the configuration parameters of at least two LCHs among the multiple LCHs match, which helps to achieve synchronous or coordinated transmission of the at least one object. Here, the matching of configuration parameters may be understood as that the parameters are identical or similar.

In some implementations, if the QoS flows associated with the at least one object are carried via multiple different LCGs, the configuration parameters of at least two LCGs among the multiple LCGs match, which helps to achieve synchronous or coordinated transmission of the at least one object. Here, the matching of configuration parameters may be understood as that the parameters are identical or similar.

In some implementations, if the QoS flows associated with the at least one object are carried via multiple different LCGs, the configuration parameters of the LCHs among these LCGs match, which helps to achieve synchronous or coordinated transmission of the at least one object. Here, the matching of LCH configuration parameters may be understood as that the parameters are identical or similar.

In some implementations, the DRBs or bearers associated with the at least one object are mapped to the same LCH, which helps to achieve coordinated or synchronous transmission of the at least one object. Of course, in the embodiments of the present application, the DRBs or bearers may be mapped to different LCHs.

In some implementations, the DRBs or bearers associated with the at least one object are mapped to the same LCG, which helps to achieve coordinated or synchronous transmission of the at least one object. Of course, in the embodiments of the present application, the DRBs or bearers associated with the at least one object can also be mapped to different LCGs.

The preceding sections have described the scheme for coordinated or synchronous transmission in the embodiments of the present application from the perspectives of DRB, bearer, LCH, and LCG. The following section describes the scheme for coordinated or synchronous transmission from the perspective of MAC PDU multiplexing.

In some implementations, the at least one object satisfies one or more of the following: the data or data packets associated with the at least one object are multiplexed into the same MAC PDU; the data or data packets associated with the at least one object are multiplexed into a plurality of consecutive MAC PDUs; the data or data packets associated with the at least one object are transmitted to the first device together; or the data or data packets are transmitted to the first device within a target time period.

In some implementations, the data or data packets associated with the at least one object are multiplexed into the same MAC PDU, or in other words, are carried in the same MAC PDU, which helps to achieve synchronous or coordinated transmission of the at least one object.

In some implementations, the data or data packets associated with the at least one object are multiplexed into a plurality of consecutive MAC PDUs, or in other words, are carried in a plurality of consecutive MAC PDUs, which helps to achieve synchronous or coordinated transmission of the at least one object. The plurality of consecutive MAC PDUs can include multiple MAC PDUs transmitted in succession.

In some implementations, the data or data packets associated with the at least one object are transmitted together to the first device. The term “transmitted together to the first device” here can be understood as “transmitted at proximate times or simultaneously.” For example, the data or data packets associated with the at least one object are carried in a single MAC PDU and transmitted to the first device.

In some implementations, the data or data packets associated with the at least one object are transmitted to the first device within a target time period, which facilitates synchronous or coordinated transmission of the at least one object. For example, if the target time period is 5 seconds, the data or data packets associated with the at least one object are transmitted to the first device within 5 seconds.

In the embodiments of the present application, the data or data packets associated with at least one object are not limited. In some implementations, the data or data packets associated with the at least one object may include relevant data packets of the at least one object, and the relevant data packets may include data packets undergoing synchronous transmission together with the at least one object, or data packets undergoing coordinated transmission together with the at least one object.

Certainly, in the embodiments of the present application, the data packets associated with at least one object may include data packets in the at least one object. If the at least one object is a QoS flow, the data packets associated with the at least one object may include data packets associated with the at least one QoS flow. If the at least one object is a data packet, the data packets associated with the at least one object may include data packets from the at least one data packet. If the at least one object is a data flow, the data packets associated with the at least one object may include data packets included in the at least one data flow. If the at least one object is a bearer, the data packets associated with the at least one object may include data packets transmitted via the at least one bearer. If the at least one object is a terminal device, the data packets associated with the at least one object may include data packets received or transmitted by the at least one terminal device.

The preceding section describes the scheme for synchronous or coordinated transmission in the embodiments of the present application from the perspective of at least one object. The following section provides a description from the perspectives of at least two objects and the target object, and reference may be made to the preceding description for the relevant introduction.

In some implementations, the at least one object includes a plurality of objects, and the plurality of objects include at least two objects. The at least two objects satisfy one or more of the following: data or data packets associated with the at least two objects are multiplexed into the same MAC PDU; data or data packets associated with the at least two objects are multiplexed into a plurality of consecutive MAC PDUs; data or data packets associated with the at least two objects are transmitted to the first device together; data or data packets associated with the at least two objects are transmitted to the first device within a target time period; data or data packets associated with the at least two objects are carried in a single MAC PDU; or data or data packets associated with the at least two objects are carried in a plurality of consecutive MAC PDUs.

In some implementations, one or more objects among the at least one object are the target object(s). The target object(s) satisfy one or more of the following: data or data packets associated with the target object(s) are multiplexed into the same MAC PDU; data or data packets associated with the target object(s) are multiplexed into a plurality of consecutive MAC PDUs; data or data packets associated with the target object(s) are transmitted to the first device within a target time period; data or data packets associated with the target object(s) are transmitted to the first device within a target time period; data or data packets associated with the target object(s) are carried in a single MAC PDU; or data or data packets associated with the target object(s) are carried in a plurality of consecutive MAC PDUs.

In the embodiments of the present application, a target object may be a specific object among the at least one object, and the specific object may be understood as an object for which a synchronous or coordinated transmission requirement exists, for which details can be found in the preceding description.

In the embodiments of the present application, the format of the aforementioned data packets or data is not limited. In some implementations, the format corresponding to the aforementioned data packets or data may include at least one of the following: a PDU, an SDU, a PDU set, a data burst, a PDU associated with the data or data packets, an SDU associated with the data or data packets, a PDU set associated with the data or data packets, or a data burst associated with the data or data packets.

In some other implementations, the aforementioned data packets may be specific data packets. For example, they may be data packets of a specific importance. As another example, they may be data packets of a specific priority. As another example, they may be data packets with a specific latency requirement. As another example, they may be data packets with a specific PDB. As another example, they may be data packets of a PSDB. Certainly, in the embodiments of the present application, the aforementioned data packets can be any data packets.

In some other implementations, the aforementioned data may be specific data. For example, it may be data of a specific importance. As another example, it may be data of a specific priority. As another example, it may be data with a specific latency requirement. Certainly, in the embodiments of the present application, the aforementioned data can be any data.

In some implementations, the second device may transmit third information to the first device to indicate that the first information is to be transmitted. That is, before step S210, the second device transmits the third information to the first device.

In some implementations, the third information is used to indicate one or more of the following: part or all of the target objects are to be transmitted; data or data packets associated with target object(s) are to be transmitted; the size of transmission resources required for transmitting target object(s); the size of transmission resources required for transmitting the object(s) to be transmitted among target objects the data amount or data amount information of the object(s) to be transmitted among target objects; remaining delay information or allowed delay information of the data of the object(s) to be transmitted among target objects; or the data amount information of an object corresponding to a specific remaining delay or allowed delay among the object(s) to be transmitted among target objects; the data amount information of an object corresponding to delay status reporting information among the object(s) to be transmitted among target objects.

In some implementations, the remaining delay may pertain to a set of data. During transmission, when the transmission of this set of data begins, the transmission delay for this set of data starts to be calculated. Correspondingly, the remaining delay for the data to be transmitted may be the total transmission delay minus the delay consumed since the transmission of this set of data began. In other words, the remaining delay for the data of the object(s) to be transmitted can be understood as the amount of delay still remaining for the object(s) to be transmitted.

In some implementations, the allowed delay may pertain to one or more pieces of data. That is, the permissible delay required for transmitting the data is the allowed delay. Correspondingly, the allowed delay corresponding to the data to be transmitted may be the delay allowed for transmitting the data to be transmitted.

As described above, the third information is associated with the first information, and the third information may be associated with target object(s), where the target object(s) may be the at least one object. Certainly, in the embodiments of the present application, the target object(s) may be one or more objects among the at least one object. Alternatively, the target object(s) may be a specific object among the at least one object. Furthermore, for relevant description of the target object(s), reference may be made to the preceding description regarding the at least one object, which will not be repeated here for brevity.

In some implementations, the third information is used to indicate that part or all of the target object(s) are to be transmitted. That is to say, if the target object(s) is the at least one object, the third information is used to indicate that part or all objects among the at least one object are to be transmitted. If the target object(s) is one or more objects among the at least one object, the third information is used to indicate that the one or more objects among the at least one object are to be transmitted. If the target object(s) is a specific object among the at least one object, the third information is used to indicate that the specific object among the at least one object is to be transmitted.

In some implementations, the third information is used to indicate that data or data packets associated with the target object(s) are to be transmitted. That is to say, if the target object(s) is the at least one object, the third information is used to indicate that data or data packets associated with the at least one object are to be transmitted. If the target object(s) is one or more objects among the at least one object, the third information is used to indicate that data or data packets associated with the one or more objects among the at least one object are to be transmitted. If the target object(s) is a specific object among the at least one object, the third information is used to indicate that data or data packets associated with the specific object among the at least one object are to be transmitted.

In the embodiments of the present application, the data or data packets associated with the at least one object are not limited. For example, the data associated with the at least one object may include a portion or all of the data associated with the at least one object. As another example, the data packets associated with the at least one object may include part or all of the data packets associated with the at least one object.

In some implementations, the third information is used to indicate the size of transmission resources required for transmitting the target object(s). That is, if the target object(s) is the at least one object, the third information is used to indicate the size of transmission resources required for transmitting the at least one object. If the target object(s) is one or more objects among the at least one object, the third information is used to indicate the size of transmission resources required for transmitting the one or more objects among the at least one object. If the target object(s) is a specific object among the at least one object, the third information is used to indicate the size of transmission resources required for transmitting the specific object among the at least one object.

In some implementations, the third information is used to indicate the size of transmission resources required for transmitting the object(s) to be transmitted among the target objects, where the object(s) to be transmitted among the target objects may be objects that have not been transmitted or have not been successfully transmitted among the target objects. Furthermore, the object(s) to be transmitted may be part or all of the target objects.

That is to say, if the target object(s) is the at least one object, the third information is used to indicate the size of transmission resources required for transmitting the object(s) to be transmitted among the at least one object. If the target object(s) is one or more objects among the at least one object, the third information is used to indicate the size of transmission resources required for transmitting the object(s) to be transmitted among the one or more objects. If the target objects are specific objects among the at least one object, the third information is used to indicate the size of transmission resources required for transmitting the object(s) to be transmitted among the specific objects.

In some implementations, the third information is used to indicate the data amount information of the object(s) to be transmitted among the target objects, where the object(s) to be transmitted among the target objects may be objects that have not been transmitted or have not been successfully transmitted. Furthermore, the object(s) to be transmitted may be part or all of the target objects.

That is to say, if the target object(s) is the at least one object, the third information is used to indicate the data amount information of the object(s) to be transmitted among the at least one object. If the target object(s) is one or more objects among the at least one object, the third information is used to indicate the data amount information of the object(s) to be transmitted among the one or more objects. If the target objects are specific objects among the at least one object, the third information is used to indicate the data amount information of the object(s) to be transmitted among the specific objects.

In the embodiments of the present application, the aforementioned data amount information may include information used to indicate the data amount, or in other words, the data amount information may include information used to determine the data amount. Certainly, in the embodiments of the present application, the data amount information may be the data amount itself. Accordingly, the third information is used to indicate the data amount information of the object(s) to be transmitted among the target objects, which can be replaced that the third information is used to indicate the data amount of the object(s) to be transmitted among the target objects.

In some implementations, the third information is used to indicate the remaining delay information or allowed delay information of the data of the object(s) to be transmitted among the target objects, where the object(s) to be transmitted among the target objects may be objects that have not been transmitted or have not been successfully transmitted. Furthermore, the object(s) to be transmitted may be part or all of the target objects.

That is to say, if the target object(s) is the at least one object, the third information is used to indicate the remaining delay or allowed delay of the data of the object(s) to be transmitted among the at least one object. If the target object(s) is one or more objects among the at least one object, the third information is used to indicate the remaining delay or allowed delay of the data of the object(s) to be transmitted among the one or more objects. If the target objects are specific objects among the at least one object, the third information is used to indicate the remaining delay or allowed delay of the data of the object(s) to be transmitted among the specific objects.

In some implementations, the third information is used to indicate the data amount information of an object corresponding to a target remaining delay or a target allowed delay among the object(s) to be transmitted among the target object(s). In other words, if object 1 among the object(s) to be transmitted among the target object(s) corresponds to the target remaining delay or the target allowed delay, then the third information is used to indicate the data amount information of object 1. For the data amount information, reference may be made to the preceding description.

That is, if the target object(s) is the at least one object, the third information is used to indicate the data amount information of an object corresponding to a target remaining delay or a target allowed delay among the object(s) to be transmitted among the at least one object. If the target object(s) is one or more objects among the at least one object, the third information is used to indicate the data amount information of an object corresponding to a target remaining delay or a target allowed delay among the object(s) to be transmitted among the one or more objects. If the target objects are specific objects among the at least one object, the third information is used to indicate the data amount information of an object corresponding to a target remaining delay or a target allowed delay among the object(s) to be transmitted among the specific objects.

In the embodiments of the present application, the target remaining delay is not limited. For example, the target remaining delay may be the minimum remaining delay among the remaining delays corresponding to the object(s) to be transmitted. As another example, the target remaining delay may be the average remaining delay of the remaining delays corresponding to the object(s) to be transmitted. As another example, the target remaining latency may be the maximum remaining delay among the remaining delays corresponding to the object(s) to be transmitted.

In the embodiments of the present application, the target allowed delay is not limited. For example, the target allowed delay may be the minimum allowed delay among the allowed delays corresponding to the object(s) to be transmitted. As another example, the target allowed delay may be the average allowed delay of the allowed delays corresponding to the object(s) to be transmitted. As another example, the target allowed delay may be the maximum allowed delay among the allowed delays corresponding to the object(s) to be transmitted.

In the embodiments of the present application, the object(s) to be transmitted among the target objects may be object(s) that has not been transmitted or has not been successfully transmitted. Furthermore, the object(s) to be transmitted may be part or all of the target objects.

In some implementations, the third information is used to indicate the data amount information of an object corresponding to the delay status reporting information among the object(s) to be transmitted among the target object(s). In other words, if the delay status reporting information carries object 1 from the object(s) to be transmitted among the target object(s), the third information is then used to indicate the data amount information of object 1.

That is to say, if the target object(s) is the at least one object, the third information is used to indicate the data amount information of an object corresponding to the delay status reporting information among the object(s) to be transmitted among the at least one object. If the target object(s) is one or more objects among the at least one object, the third information is used to indicate the data amount information of an object corresponding to the delay status reporting information among the object(s) to be transmitted among the one or more objects. If the target objects are specific objects among the at least one object, the third information is used to indicate the data amount information of an object corresponding to the delay status reporting information among the object(s) to be transmitted among the specific objects.

In the embodiments of the present application, the object(s) to be transmitted among the target object(s) may be object(s) that has not been transmitted or has not been successfully transmitted. Furthermore, the object(s) to be transmitted may be part or all of the target objects.

The preceding section has introduced the content of the third information in the embodiments of the present application. The following section will describe the transmission method for the third information in the embodiments of the present application.

In some implementations, the transmission of the third information may be triggered based on a first condition, or in other words, if the first condition is met, the second device transmits the third information to the first device.

In some implementations, the first condition includes one or more of the following: the at least one object cannot be multiplexed into a single MAC PDU; the at least one object cannot be multiplexed into a plurality of consecutive MAC PDUs; the at least one object cannot be transmitted to the first device together; the at least one object cannot be carried in a single MAC PDU; or the at least one object cannot be carried in a plurality of consecutive MAC PDUs.

In some implementations, if the first condition includes that the at least one object cannot be multiplexed into the same MAC PDU, or in other words, if the first condition includes that the at least one object cannot be carried in a single MAC PDU, it may result in the transmission of the at least one object failing to meet the requirements for synchronous or coordinated transmission.

In some implementations, if the first condition includes that the at least one object cannot be multiplexed into a plurality of consecutive MAC PDUs, or in other words, if the first condition includes that the at least one object cannot be carried in a plurality of consecutive MAC PDUs, it may result in the transmission of the at least one object failing to meet the requirements for synchronous or coordinated transmission.

In some implementations, if the first condition includes that the at least one object cannot be transmitted to the first device together, it may result in the transmission of the at least one object failing to meet the requirements for synchronous or coordinated transmission. Herein, that the at least one object cannot be transmitted to the first device together may be understood as that the at least one object cannot be transmitted to the first device simultaneously, or that all of the at least one object cannot be transmitted to the first device within a certain time period.

In some implementations, the data associated with the third information satisfies one or more of the following: a scheduling priority of the data associated with the third information is higher than a scheduling priority of first data; a transmission priority of the data associated with the third information is higher than a transmission priority of the first data; an LCH priority of the data associated with the third information is higher than an LCH priority of the first data; or a multiplexing priority of the data associated with the third information is higher than a multiplexing priority of the first data.

In some implementations, the scheduling priority is used to indicate the order in which data is scheduled. Typically, data with a higher scheduling priority is scheduled before data with a lower scheduling priority.

In some implementations, the transmission priority is used to indicate the order in which data is transmitted. Typically, data with a higher transmission priority is transmitted before data with a lower transmission priority.

In some implementations, the LCH priority is used to indicate the order in which data is mapped to an LCH. Typically, data with a higher LCH priority is mapped to the LCH before data with a lower LCH priority.

In some implementations, the multiplexing priority of the data associated with the third information is higher than the multiplexing priority of other data. The multiplexing priority here can be understood as the priority for the data associated with the third information to be multiplexed into a MAC PDU. That is, the priority for the data associated with the third information to be multiplexed into a MAC PDU is higher than the priority for other data to be multiplexed into a MAC PDU.

In some implementations, the data associated with the third information can be understood as data associated with the target object. For the target object, reference may be made to the preceding description. Furthermore, other data refers to the data to be transmitted other than the data associated with the third information, or in other words, other data refers to data to be transmitted from the second device other than the data associated with the third information.

In some implementations, if the first information is associated with the synchronous or coordinated transmission of data or data packets of at least one object, then the data associated with the first information satisfies one or more of the following: a scheduling priority of the data associated with the first information is higher than a scheduling priority of other data; a transmission priority of the data associated with the first information is higher than a transmission priority of other data; an LCH priority of the data associated with the first information is higher than an LCH priority of other data; or a multiplexing priority of the data associated with the first information is higher than a multiplexing priority of other data. This scheme helps to improve the probability of successful synchronous or coordinated transmission of the first information.

In some implementations, the multiplexing priority of the data associated with the first information is higher than the multiplexing priority of other data. The multiplexing priority here can be understood as the priority for the data associated with the first information to be multiplexed into a MAC PDU. That is, the priority for the data associated with the first information to be multiplexed into a MAC PDU is higher than the priority for other data to be multiplexed into a MAC PDU.

In some implementations, the data associated with the first information can be understood as data associated with the target object. For the target object, reference may be made to the preceding description. Furthermore, other data refers to data to be transmitted other than the data associated with the first information, or in other words, other data refers to data to be transmitted from the second device other than the data associated with the first information.

In some implementations, the LCH priorities associated with the at least one object are identical or similar, which helps to achieve synchronous or coordinated transmission of the at least one object.

In the embodiments of the present application, the similarity of LCH priorities associated with the at least one object is not limited. In some implementations, that the LCH priorities associated with the at least one object are similar may mean that the difference between the highest priority and the lowest priority among the LCH priorities associated with the at least one object is less than or equal to a priority threshold. For example, the priority threshold is one priority level, and the highest LCH priority associated with the at least one object is a first priority, while the lowest LCH priority is a second priority. When the difference between the first priority and the second priority is an exact priority level, that is, the difference equals to the priority threshold, the LCH priorities associated with the at least one object are considered similar.

In other implementations, that the LCH priorities associated with the at least one object are similar may mean that that the LCH priorities associated with the at least one object fall within a priority range. For example, the priority range is [priority 1; priority 2; priority 3], and the LCH priorities associated with the at least one object are priority 1 and priority 2, respectively. Then, the LCH priorities associated with the at least one object fall within the priority range, and thus are considered similar.

In some implementations, the aforementioned method further includes: the second device transmits fourth information to the first device, where the fourth information is used to indicate whether the second device supports transmitting the first information, and/or the fourth information is used to indicate whether the second device has available first information.

That is to say, before the second device transmits the first information to the first device, the second device may transmit the fourth information to the first device so that the first device can prepare to receive the first information. For example, the second device can transmit the fourth information to the first device, and correspondingly, the first device can allocate resources to the second device for transmitting the first information.

In the embodiments of the present application, the aforementioned fourth information and third information may be the same information. For example, the third information may indirectly indicate the fourth information. Certainly, in the embodiments of the present application, the fourth information may be different from the third information. For example, the fourth information may be information transmitted before the third information, or the fourth information may be transmitted simultaneously with the third information.

In the embodiments of the present application, the first device and the second device are not limited. For example, the first device is an access network device, and the second device is a terminal device or a first core network device. As another example, both the first device and the second device can be terminal devices. As still another example, the first device can be a second core network device, and the second device is a terminal device. As still another example, the first device can be a second core network device, and the second device is a first core network device.

For ease of understanding, the method in the embodiments of the present application will be described below with reference to Embodiment 1 and Embodiment 2. In Embodiment 1, the transmission of the first information via control plane information is described, while in Embodiment 2, the transmission of the first information via user plane information is described. Furthermore, in Embodiment 1 and/or Embodiment 2, the first device can be an access network device, and the second device can be a terminal device or a core network device.

FIG. 8 is a schematic flowchart of a wireless communication method according to Embodiment 1 of the present application. The method shown in FIG. 8 includes steps S810 and S820.

In step S810, the second device transmits first information (also referred to as “multi-modality information or requirements”) to the first device.

In some implementations, the first information may be transmitted to the first device in the case where the second device has obtained the first information. In other implementations, the second device may notify the first device of the first information when the first device requests to obtain it.

In some implementations, the terminal device can indicate to the base station whether it supports the reporting of the first information. In the embodiments of the present application, only a second device that supports the reporting of the first information can report the first information, which facilitates compatibility with second devices of different capabilities. Furthermore, the scheme of the embodiments of the present application does not require all second devices to support the function of reporting the first information, which helps to reduce the complexity of the second devices.

In some implementations, the methods for the terminal device to obtain the first information may include one or more of the following: the higher layer of the terminal device deliver the first information to the lower layer of the terminal device (e.g., implemented within the terminal device, or by carrying the first information in packet header information); or a core network device informs the terminal device of the first information, for example, the core network device can transmit the first information to the terminal device via NAS signaling.

Implementation 1: the terminal device reports the first information.

In some implementations, the terminal device reports the first information via a UL RRC message, where the UL RRC message may be UE assistance information.

In some implementations, the terminal device reports the first information via a UL NAS message, where the UL NAS message may be an UL information transfer (ULinformationTransfer). Certainly, in the embodiments of the present application, the aforementioned first information may be carried in other NAS messages. For example, after obtaining the first information from the terminal device, the core network device can forward the first information to an access network device.

In the embodiments of the present application, since the terminal device has a clearer understanding of the uplink transmission requirements or information, the transmission of the first information by the terminal device allows for a more accurate and timely reflection of the service transmission requirements (e.g., coordinated or synchronous transmission).

In some implementations, the network device carries indication information (e.g., the request message described previously) in other configurations (otherconfig) to indicate the terminal device to report the first information. For example, a first indication is carried in otherconfig to indicate or enable the terminal device to report the first information. As another example, a specific QoS flow index or QoS flow list is indicated in other configurations (otherconfig), and correspondingly, the first information transmitted by the terminal device is associated with the specific QoS flow index or QoS flow list.

In some implementations, the terminal device reports the first information when a first condition is met, where the first condition includes at least one of the following: a first information reporting prohibition timer for the terminal device or for a QoS flow is not running; a first information reporting prohibition timer for the terminal device or for a QoS flow expires; the terminal device has not yet reported its first information while reporting is configured; the terminal device has not yet reported the first information for a QoS flow while reporting is configured; the terminal device has not yet reported the first information for a specific QoS flow while reporting is configured; there is a change in the first information compared to the last reported first information; or the magnitude of change in the information content of the first information compared to the last reported first information is greater than a threshold.

If there is a change in the first information compared to the last reported first information, the first condition may include one or more of the following: there is a change in the first information reported for the terminal device; there is a change in the first information reported for a QoS flow; or there is a change in the first information reported for a specific QoS flow.

If the magnitude of change in the information content of the first information compared to the last reported first information is greater than a threshold, the first condition includes that the change in the first information reported for a specific QoS flow is greater than a threshold.

In the embodiments of the present application, determining whether to report the first information based on the first condition helps to ensure the timely reporting of the first information by the terminal device while reducing the possibility of excessive air interface resource overhead caused by frequent transmission of the first information.

In some implementations, the indication granularity of the first information is per QoS flow. For example, the first information is associated with QoS flow 1. As another example, the first information is associated with an identifier of a QoS flow for which a synchronous or coordinated transmission requirement exists or a QoS flow list for which a synchronous or coordinated transmission requirement exists. As another example, the first information indicates whether QoS flow 1 is flagged. As another example, the first information indicates one or more QoS flows and, for each QoS flow, indicates the identifier of a QoS flow or a QoS flow list for which a synchronous or coordinated transmission requirement exists with that QoS flow.

In the embodiments of the present application, since different QoS flows may support different services, or some QoS flows may not support synchronous or coordinated transmission (also known as multi-modality transmission requirements), or some QoS flows may support non-multi-modality services, reporting the first information based on QoS flows can accurately reflect the synchronous or coordinated transmission requirements for different QoS flows.

In some implementations, the first information can be carried in the UL-TrafficInfo→PDU-SessionUL-TrafficInfo→QOS-FlowUL-TrafficInfo IE. Herein, the QFI in the aforementioned IE may be the identifier of the QoS flow or QoS flow list associated with the first information, or the first information is used to indicate whether the QFI in the aforementioned IE is flagged.

In some implementations, new UAI may be introduced in the UE assistance information to carry the first information. For example, new UAI is introduced to carry the first information to indicate the requirement for synchronous or coordinated transmission between QoS flows. As another example, new UAI is introduced to carry the first information to indicate one or more QoS flows and, for each QoS flow, to indicate the identifier of a QoS flow or a QoS flow list for which a synchronous or coordinated transmission requirement exists with that QoS flow. Or, as still another example, new UAI is introduced to carry the first information to indicate which QoS flows are flagged.

Implementation 2: the core network device reports the first information.

In some implementations, the core network device can indicate the first information via a CP message. The CP message may be the TSCAI. Since the TSCAI is indicated per QoS flow, adding the first information associated with the corresponding QoS flow in a TSCAI message helps to reuse known communication procedures. Herein, the first information is used to indicate identifiers of other QoS flows or a QoS flow list for which a synchronous or coordinated transmission with the QoS flow corresponding to the TSCAI exists, or the first information is used to indicate whether the QoS flow corresponding to the TSCAI is flagged. Certainly, in the embodiments of the present application, the first information may also be indicated via other CP plane information.

In the present application embodiment, in the case where the CN can obtain the UL service information (i.e., the first information), existing signaling and procedures are utilized as much as possible to transmit the first information to the access network device, thereby avoiding an increase in air interface signaling overhead caused by the reporting of the first information performed by the terminal device. Furthermore, the core network device informs the base station of both UL and DL related information together to reduce the signaling overhead for the CN to transmit the first information.

In some implementations, the first information may be used to indicate one or more of the following: an association relationship between QoS flows, a binding relationship between QoS flows, a synchronous relationship between QoS flows, or a coordinated relationship between QoS flows. For example, the first information may indicate a QoS flow index or a QoS flow list associated with QoS flow 1. As another example, the first information may indicate whether a certain QoS flow is flagged. For a flagged QoS flow, a synchronous or coordinated transmission requirement exists, whereas for an unflagged QoS flow, no synchronous or coordinated transmission requirement exists.

In step S820, the first device performs related operations based on the first information.

In the embodiments of the present application, the aforementioned related operations may include one or more of the following: the first device performs configuration for the QoS flows associated with the first information based on the first information; the first device performs scheduling for the QoS flows associated with the first information based on the first information; or for example, the first device performs resource allocation for the QoS flows associated with the first information based on the first information.

In some implementations, QoS flows for which a multi-modality requirement exists (or for which a synchronous or coordinated transmission requirement exists) may be mapped to the same data radio bearer (DRB), which helps avoid impacts on lower layers of the second device (such as the PDCP layer, RLC layer, and MAC layers), thereby reducing the implementation complexity of the terminal device.

In some implementations, one or more of the following Manner 1 to Manner 3, may be employed to map the QoS flows associated with the first information to the same DRB.

Manner 1: QoS flows associated with the first information are mapped to one DRB by means of RRC configuration. For example, in the SDAP configuration, a single DRB/SDAP configuration is associated with all QoS flows for which a synchronous or coordinated transmission requirement exists. That is, in the SDAP configuration corresponding to one DRB, the QoS flows for with synchronous or coordinated transmission requirements exist are added to the mappedQoS-FlowsToAdd IE.

In some implementations, when a certain QoS flow among those QoS flows for with a synchronous or coordinated transmission requirement exists is deleted from the SDAP configuration, other QoS flows associated with that QoS flow in the SDAP configuration are also deleted. There exist a synchronous or coordinated transmission requirement between the other QoS flows and that QoS flow.

Manner 2: QoS flows associated with the first information are associated with a default data radio bearer (default DRB) by means of RRC configuration. For example, in the SDAP configuration, all QoS flows for which a synchronous or coordinated transmission requirement exists are associated with the default DRB. That is, in the SDAP configuration corresponding to one default DRB, all QoS flows for which a synchronous or coordinated transmission requirement exists are added to the mappedQoS-FlowsToAdd IE.

In some implementations, when a certain QoS flow among those QoS flows for with a synchronous or coordinated transmission requirement exists is deleted from the SDAP configuration, other QoS flows associated with that QoS flow in the SDAP configuration are also deleted. There exist a synchronous or coordinated transmission requirement between the other QoS flows and that QoS flow.

Manner 3: the DL SDAP header is used to indicate the mapping relationship between QoS flows and DRBs. For example, according to the indication in the DL SDAP header, the terminal device performs UL reflective mapping between QoS flow and DRB. That is to say, when the terminal device receives a DL SDAP data PDU, if its DL SDAP header carries a QFI, and the RDI indicates a specific value (e.g., the specific value is 1, which indicates that the mapping relationship between DRBs and QoS flows needs to be updated or that the QoS flow to DRB mapping rule needs to be stored), the terminal device accordingly performs UL reflective mapping between QoS flows and DRBs based on the RDI, or modifies the mapping relationship between UL QoS flows and DRBs.

In some implementations, in the case where the QoS flows associated with the first information are mapped to the same DRB, the network device can configure a first parameter based on the mapping relationship between QoS flows and DRBs or the first information. The first parameter includes at least one of the following: the prioritized bit rate (PBR) or the depth parameter BSD (bucketSizeDuration) of the token bucket. This helps ensure that the QoS flows for which a multi-modality requirement exists or their data can be transmitted synchronously or coordinately.

In other implementations, mapping QoS flows for which a multi-modality requirement exists to different DRBs helps to avoid impacts on higher layers (such as the SDAP layer).

In some implementations, in the case where QoS flows are mapped to different DRBs, one or more of the configuration parameters corresponding to those DRBs—such as LCH configuration parameters, PDCP configuration parameters, or DRB configuration parameters—are the same or similar. This facilitates the coordinated or synchronous transmission of multi-modality services.

In some implementations, in the case where QoS flows are mapped different DRBs occurs, the LCP mapping restrictions corresponding to those DRBs are identical or similar, which facilitates the coordinated or synchronous transmission of multi-modality services.

In some implementations, in the case where QoS flows are mapped different DRBs occurs, data with a multi-modality requirement can be multiplexed into the same MAC PDU, or LCHs with the same LCH priority are multiplexed to a MAC PDU, which facilitates the coordinated or synchronous transmission of multi-modality services.

It should be understood that the solution in the embodiments of the present application can be applied to SL scenarios. In this case, the terminal device can report the multi-modality information of the SL UE's QoS flow (as an example of the first information) to the network device. In some implementations, the network device indicates the UE to transmit the first information via the configuration information “sl-AssistanceConfigNR”. In some implementations, the UE can use the “sl-UE-AssistanceInformationNR” information or add another UE assistance information IE to indicate the first information.

In the embodiments of the present application, a manner is introduced for enabling the first device to obtain UL/DL a multi-modality requirement (as an example of the first information) via the control plane to perform multi-modality transmission, which helps to achieve coordinated or synchronous transmission.

FIG. 9 is a schematic flowchart of a wireless communication method according to Embodiment 2 of the present application. The method shown in FIG. 9 includes steps S910 and S920.

In step S910, the second device transmits first information (also referred to as “multi-modality information or requirements”) to the first device.

In some implementations, the first information may be transmitted to the first device in the case where the second device has obtained the first information. In other implementations, the second device may notify the first device of the first information when the first device requests to obtain it.

In some implementations, the terminal device can indicate to the base station whether it supports the reporting of the first information. In the embodiments of the present application, only a second device that supports the reporting of the first information can report the first information, which facilitates compatibility with second devices of different capabilities. Furthermore, the solution in the embodiments of the present application does not require all second devices to support the function of reporting the first information, which helps to reduce the complexity of the second device.

In some implementations, the access network device indicates the UE to report the first information through one or more of the following information: RRC configuration, DL MAC CE, or DCI.

In some implementations, the access network device indicates or enables the second device to report the first information through one or more of the following information: RRC configuration, DL MAC CE, or DCI.

In some implementations, the access network device indicates the reporting of the first information for a specific QoS flow index or a QoS flow list in one or more of RRC configuration, DL MAC CE, or DCI. This helps to prevent the second device from reporting the first information for all QoS flows, or in other words, helps to avoid situations where the second device reports first information that the first device is not interested in, thereby improving the utilization of transmission resources for the first information.

Implementation 1: the terminal device reports the first information.

In some implementations, the terminal device may determine to transmit the first information based on a pre-defined or pre-configured manner. In the embodiments of the present application, the terminal device may report the first information to the first device after obtaining it.

In the embodiments of the present application, the terminal device may obtain the first information in one or more of the following ways: the higher layer of the terminal device delivers the first information to its lower layer; the first information is obtained through the UE implementation; the first information is carried in the header information of a data packet transmitted to the terminal device; or the core network device informs the terminal device of the first information, for example, by transmitting the first information via NAS signaling.

In some implementations, the terminal device (UE) reports the first information through data plane information, where the data plane information may include one or more of the following: an SDAP control PDU, an SDAP data PDU, a MAC PDU, a MAC CE, or UCI.

In the embodiments of the present application, since the terminal device has a clearer understanding of uplink transmission requirements or information, the transmission of the first information by the terminal device helps to reflect the service demands and characteristics more accurately and timely.

In some implementations, the first information is carried by means of an SDAP control PDU. Since the mapping between QoS flows and DRBs is implemented at the SDAP layer, carrying the first information by means of an SDAP control PDU can reduce the impact on other layers while reusing the existing architecture as much as possible.

Furthermore, carrying the first information by means of an SDAP control PDU helps to avoid introducing a new data PDU format, thereby reducing the complexity of the second device.

In some implementations, the first information is carried via an SDAP control PDU, and the first information is used to indicate one or more of the following: whether a QoS flow is flagged; information about QoS flows associated with a first QoS flow; QoS flows that need to be mapped to one DRB; or QoS flows that have an association or binding relationship.

In some implementations, the transmission of the first information via an SDAP control PDU can be used when it is enabled by the configuration of the UE by the network. In the present application, the transmission of the first information via an SDAP control PDU can be predefined by the protocol; alternatively, any second device having the capability to report the first information can transmit the first information via an SDAP control PDU; alternatively, a second device that has first information to be transmitted and the capability to report the first information transmits the first information via an SDAP control PDU; alternatively, a second device of a specific version can transmit the first information via an SDAP control PDU.

To distinguish SDAP control PDUs, an R bit in an existing SDAP control PDU is used to indicate that the control PDU is a new SDAP control PDU, i.e., an SDAP control PDU carrying the first information. For example, as shown in FIG. 3, the R bit in the End-Marker Control PDU is reused. If the R bit is set to 1, it indicates that the SDAP control PDU is not an End-Marker Control PDU, or that the SDAP control PDU is an SDAP control PDU carrying the first information. Correspondingly, the receiving end cannot ignore the R bit in the SDAP control PDU.

Continuing to refer to FIG. 5, the R bit in the End-Marker Control PDU is used. For example, if the R bit is set to 1, it indicates that the control PDU is not an End-Marker Control PDU. For forward compatibility, a PDU type may be introduced to indicate the type of the corresponding control PDU when the R bit is set to 1. The PDU type may occupy 1, 2, 3, or X bits. For example, when PDU type=00, it can identify the control PDU as one carrying the first information. Correspondingly, the receiving end cannot ignore the R bit in the control PDU.

Of course, in the embodiments of the present application, if the UE supports reporting the first information, the receiving end cannot ignore the R bit in the SDAP control PDU, and/or if the network device indicates the terminal device to report the first information, the receiving end cannot ignore the R bit in the SDAP control PDU.

In some implementations, the UE UL may carry the first information in an SDAP control PDU, where the first information is used to indicate one or more of the following: an association relationship between QoS flows; that the corresponding QoS flow in the control PDU needs to be updated or mapped to a DRB; or that the network should update the mapping relationship between QoS flows and DRBs.

In some implementations, when the UE receives an ACK from the base station in response to the control PDU, or when the UE transmits an SDAP control PDU, the UE SDAP performs one or more of the following: store the updated mapping relationship; update the mapping relationship between QoS flows and DRBs; or deliver an End-Marker Control PDU to a lower layer, such as the PDCP layer.

In some implementations, the first information is carried via an SDAP data PDU. Since the mapping between QoS flows and DRBs is currently implemented at the SDAP layer, carrying the first information via an SDAP data PDU can reduce the impact on other layers while reusing the existing architecture as much as possible.

In some implementations, a new SDAP data PDU is introduced, which is an UL PDU. This SDAP data PDU is used to indicate the first information.

In some implementations, this SDAP data PDU is used when it is enabled by the configuration of UE by the network. For example, if the network device configures an SDAP data PDU with an SDAP header for the UE and configures the UE to report the first information, then the SDAP data PDU is enabled. As another example, if the network device configures an SDAP data PDU with an enhanced SDAP header for the UE and configures the UE to report the first information, then the SDAP data PDU is enabled.

Conversely, if the network device does not configure an SDAP data PDU with an enhanced SDAP header and/or the reporting of the first information for the terminal device, the terminal device transmits data according to known rules. For example, in the case where the network device configures an SDAP header for the terminal device, the terminal device transmits data in the format specified in section 6.2.2.3 of SDAP specification. As another example, in the case where the network device does not configure an SDAP header, the terminal device transmits data in the format specified in section 6.2.2.1 of SDAP specification.

Of course, in the embodiments of the present application, enabling the SDAP data PDU may be predefined by the protocol. For example, the protocol may predefine that the SDAP data PDU can be enabled for a UE with the capability to report the first information. As another example, the protocol may predefine that the SDAP data PDU can be enabled for a UE that has first information to transmit. As another example, the protocol may predefine that the SDAP data PDU can be enabled for a specific version of UE. As another example, the protocol may predefine that the SDAP data PDU can be enabled for a UE that needs to update or report the first information.

Continuing to refer to FIG. 6, the new SDAP data PDU includes at least one of the following information: a D/C indicator used to indicate whether the SDAP PDU is a control PDU or a data PDU; a QoS flow identifier (e.g., QFI); the QoS flow associated with the QoS flow identified by the QFI (or, the identifier (QFI or QFI list) of the QoS flow that needs to be mapped to a DRB, or whether the QoS flow corresponding to the QFI is a flagged QoS flow); an RDI indicator used to indicate whether the (UL) QoS flow to DRB mapping rule is updated; or an RQI indicator used to indicate whether to notify the CN NAS that the UL is to update the mapping from SDF to QoS flow. Additionally, the identifier of the DRB to which the QoS flow needs to be mapped is indicated in the data PDU, e.g., the DRB to be mapped is directly indicated in the SDAP data PDU, which helps to reduce the complexity of the second device.

In other implementations, continuing to refer to FIG. 7, the following information are included: the D/C indicator used to indicate whether the SDAP PDU is a control or data PDU; a QoS flow identifier (e.g., QFI); the QoS flow associated with the QoS flow identified by the QFI (or, the identifier (QFI or QFI list) of the QoS flow that needs to be mapped to a DRB, or whether the QoS flow corresponding to the QFI is a flagged QoS flow); an RDI indicator used to indicate whether the (UL) QoS flow to DRB mapping rule is updated; or an RQI indicator used to indicate whether to notify the CN NAS that the UL is to update the mapping from SDF to QoS flow. Furthermore, if the associated QoS flows need to be mapped to one DRB, for example, both QoS flow 1 and QoS flow 2 are mapped to DRB1, then DRB1 is used to transmit the new data PDU for both QoS flow 1 and QoS flow 2, so as to indicate that both QoS flow 1 and QoS flow 2 will be mapped to DRB1. Alternatively, if QoS flow 1 is already mapped to DRB1, then DRB1 is used to transmit the new data PDU for QoS flow 2, so as to indicate that QoS flow 2 will also be mapped to DRB1. The SDAP data PDU in the embodiments of the present application can reuse existing formats as much as possible.

In some implementations, if the first information is carried via an SDAP data PDU and the SDAP data PDU includes specific information (e.g., RDI=1), the UE SDAP stores the updated mapping relationship (the mapping between QoS flows and DRBs) and transmits an End-Marker Control PDU to a lower layer (e.g., PDCP).

In some implementations, the first information may be carried via a MAC PDU. For example, the first information may be carried in a MAC PDU or by using a MAC CE of the MAC PDU.

Implementation 2: the core network device reports the first information.

In some implementations, the core network device may carry the first information in the header of a data packet. For example, the identifier of the associated data packet and/or the associated QoS flow may be indicated in the header of the data packet. As another example, this data packet or whether the QoS flow of this data packet is flagged may be indicated in the header of the data packet.

In the present application, in the case where the CN can obtain the UL service information (i.e., the first information), existing signaling and procedures are utilized as much as possible to transmit the first information to the access network device, thereby avoiding an increase in air interface signaling overhead caused by the reporting of the first information performed by the terminal device. Furthermore, the core network device informs the base station of both UL and DL related information together to reduce the signaling overhead for the CN to transmit the first information.

In some implementations, the first information may be used to indicate one or more of the following: an association relationship between QoS flows, a binding relationship between QoS flows, a synchronous relationship between QoS flows, or a coordinated relationship between QoS flows. For example, the first information may indicate a QoS flow index or a QoS flow list associated with QoS flow 1. As another example, the first information may indicate whether a certain QoS flow is flagged. For a flagged QoS flow, a synchronous or coordinated transmission requirement exists, whereas for an unflagged QoS flow, no synchronous or coordinated transmission requirement exists

In step S920, the first device performs related operations based on the first information.

In the embodiments of the present application, the aforementioned related operations may include one or more of the following: the first device performs configuration for the QoS flows associated with the first information based on the first information; the first device performs scheduling for the QoS flows associated with the first information based on the first information; or for example, the first device performs resource allocation for the QoS flows associated with the first information based on the first information.

In some implementations, QoS flows for which a multi-modality requirement exists (or for which a synchronous or coordinated transmission requirement exists) may be mapped to the same data radio bearer (DRB), which helps avoid impacts on lower layers of the second device (such as the PDCP layer, RLC layer, and MAC layers), thereby reducing the implementation complexity of the terminal device.

In some implementations, one or more of the following Manner 1 to Manner 3, may be employed to map the QoS flows associated with the first information to the same DRB.

Manner 1: QoS flows associated with the first information are mapped to one DRB by means of RRC configuration. For example, in the SDAP configuration, a single DRB/SDAP configuration is associated with all QoS flows for which a synchronous or coordinated transmission requirement exists. That is, in the SDAP configuration corresponding to one DRB, the QoS flows for with synchronous or coordinated transmission requirements exist are added to the mappedQoS-FlowsToAdd IE.

In some implementations, when a certain QoS flow among those QoS flows for with a synchronous or coordinated transmission requirement exists is deleted from the SDAP configuration, other QoS flows associated with that QoS flow in the SDAP configuration are also deleted. There exist a synchronous or coordinated transmission requirement between the other QoS flows and that QoS flow.

Manner 2: QoS flows associated with the first information are associated with a default data radio bearer (default DRB) by means of RRC configuration. For example, in the SDAP configuration, all QoS flows for which a synchronous or coordinated transmission requirement exists are associated with the default DRB. That is, in the SDAP configuration corresponding to one default DRB, all QoS flows for which a synchronous or coordinated transmission requirement exists are added to the mappedQoS-FlowsToAdd IE.

In some implementations, when a certain QoS flow among those QoS flows for with a synchronous or coordinated transmission requirement exists is deleted from the SDAP configuration, other QoS flows associated with that QoS flow in the SDAP configuration are also deleted. There exist a synchronous or coordinated transmission requirement between the other QoS flows and that QoS flow.

Manner 3: the DL SDAP header is used to indicate the mapping relationship between QoS flows and DRBs. For example, according to the indication in the DL SDAP header, the terminal device performs UL reflective mapping between QoS flow and DRB. That is to say, when the terminal device receives a DL SDAP data PDU, if its DL SDAP header carries a QFI, and the RDI indicates a specific value (e.g., the specific value is 1, which indicates that the mapping relationship between DRBs and QoS flows needs to be updated or that the QoS flow to DRB mapping rule needs to be stored), the terminal device accordingly performs UL reflective mapping between QoS flows and DRBs based on the RDI, or modifies the mapping relationship between UL QoS flows and DRBs.

In some implementations, in the case where the QoS flows associated with the first information are mapped to the same DRB, the network device can configure a first parameter based on the mapping relationship between QoS flows and DRBs or the first information. The first parameter includes at least one of the following: the prioritized bit rate (PBR) or the depth parameter BSD (bucketSizeDuration) of the token bucket. This helps ensure that the QoS flows for which a multi-modality requirement exists or their data can be transmitted synchronously or coordinately.

In other implementations, mapping QoS flows for which a multi-modality requirement exists to different DRBs helps to avoid impacts on higher layers (such as the SDAP layer).

In some implementations, in the case where QoS flows are mapped to different DRBs, one or more of the configuration parameters corresponding to those DRBs—such as LCH configuration parameters, PDCP configuration parameters, or DRB configuration parameters—are the same or similar. This facilitates the coordinated or synchronous transmission of multi-modality services.

In some implementations, in the case where QoS flows are mapped different DRBs occurs, the LCP mapping restrictions corresponding to those DRBs are identical or similar, which facilitates the coordinated or synchronous transmission of multi-modality services.

In some implementations, in the case where QoS flows are mapped different DRBs occurs, data with a multi-modality requirement can be multiplexed into the same MAC PDU, or LCHs with the same LCH priority are multiplexed to a MAC PDU, which facilitates the coordinated or synchronous transmission of multi-modality services.

It should be understood that the solution in the embodiments of the present application can be applied to SL scenarios. In this case, the terminal device can report the multi-modality information of the SL UE's QoS flow (as an example of the first information) to the network device. In some implementations, the network device indicates the UE to transmit the first information via the configuration information “sl-AssistanceConfigNR”. In some implementations, the UE can use the “sl-UE-AssistanceInformationNR” information or add another UE assistance information IE to indicate the first information.

In the embodiments of the present application, a solution for transmitting the first information via the user plane is introduced, which helps to achieve synchronous or coordinated transmission of the QoS flows associated with the first information.

The method embodiments of the present application have been described in detail above with reference to FIGS. 1 to 9. Hereinafter, the apparatus embodiments of the present application will be described in detail with reference to FIGS. 10 to 12. It should be understood that the descriptions of the method embodiments and the apparatus embodiments correspond to each other; therefore, parts not described in detail can be referred to in the preceding method embodiments.

FIG. 10 is a schematic diagram of a communication device according to an embodiment of the present application. The communication device 1000 shown in FIG. 10 is a second device, and the communication device 1000 includes a transmitting unit 1010.

The transmitting unit 1010 is configured to transmit first information to a first device, where the first information is associated with synchronous transmission or coordinated transmission of at least one object.

In some implementations, the first information is used to indicate one or more of the following: a synchronous transmission requirement exists for the at least one object; a coordinated transmission requirement exists for the at least one object; a parameter for synchronous transmission of the at least one object; a parameter for coordinated transmission of the at least one object; identification information corresponding to the at least one object; a type corresponding to the at least one object; whether the at least one object corresponds to target identification information; whether the at least one object corresponds to a target type; a requirement for synchronous transmission between at least two objects; a requirement for coordinated transmission between at least two objects; a parameter for synchronous transmission between at least two objects; a parameter for coordinated transmission between at least two objects; performing synchronous transmission between at least two objects; performing coordinated transmission between at least two objects; whether at least two objects correspond to same identification information; whether at least two objects correspond to a same type; whether at least two objects correspond to target identification information; whether at least two objects correspond to a target type; an association relationship between at least two objects; or a binding relationship between at least two objects; where if the at least one object includes a plurality of objects, then the at least one object includes the at least two objects.

In some implementations, an object among the at least one object includes one of the following: a Quality of Service (QoS) flow, a data flow, a terminal device, a protocol data unit (PDU) session, or a radio bearer.

In some implementations, the identification information includes one or more of the following: identification information of a target object, where the target object is part or all of the at least one object; identification information of a first object among the at least one object; identification information of each object among the at least one object; or identification information for identifying at least two objects; where if the at least one object includes a plurality of objects, then the at least one object includes the at least two objects.

In some implementations, the transmission of the first information is triggered based on one or more of the following: a period; a first event; a request message transmitted by the first device; an enabling indication used to enable the second device to transmit the first information; a capability of the second device that is associated with synchronous transmission or coordinated transmission of the at least one object; whether the first device has obtained the first information; or whether the second device has available or valid first information.

In some implementations, the first event includes one or more of the following: a first duration is exceeded; the second device is configured to transmit the first information of the at least one object; the first information of the at least one object has not yet been transmitted; a requirement for synchronous transmission of the at least one object changes; a requirement for coordinated transmission of the at least one object changes; a parameter for synchronous transmission of the at least one object changes; a parameter for coordinated transmission of the at least one object changes; an identifier for synchronous transmission of the at least one object changes; a type for synchronous transmission of the at least one object changes; an identifier for coordinated transmission of the at least one object changes; a type for coordinated transmission of the at least one object changes; an identifier for synchronous transmission between at least two objects changes; a type for synchronous transmission between at least two objects changes; an identifier for coordinated transmission between at least two objects changes; a type for coordinated transmission between at least two objects changes; a requirement for coordinated transmission between at least two objects changes; a requirement for synchronous transmission between at least two objects changes; a parameter for coordinated transmission between at least two objects changes; a parameter for synchronous transmission between at least two objects changes; a change in the requirement for synchronous transmission of the at least one object is greater than or equal to a first change threshold; a change in the requirement for coordinated transmission of the at least one object is greater than or equal to a second change threshold; a change in the parameter for synchronous transmission of the at least one object is greater than or equal to a third change threshold; a change in the parameter for coordinated transmission of the at least one object is greater than or equal to a fourth change threshold; a change in the parameter for synchronous transmission between the at least two objects is greater than or equal to a fifth change threshold; a change in the parameter for coordinated transmission between the at least two objects is greater than or equal to a sixth change threshold; a change in the requirement for synchronous transmission between the at least two objects is greater than or equal to a seventh change threshold; or a change in the requirement for coordinated transmission between the at least two objects is greater than or equal to an eighth change threshold.

In some implementations, the first duration is a duration during which transmission of the first information is prohibited or not allowed; or the first duration is a duration during which transmission of the first information of the at least one object is prohibited or not allowed.

In some implementations, a configuration granularity of the first duration is one object among the at least one object; and/or the first duration is used for one object among the at least one object.

In some implementations, the object associated with the configuration granularity is different from the object for which the first duration is used, or the object associated with the configuration is the same as the object for which the first duration is used.

In some implementations, the first duration is determined based on a first timer, and the first event includes the expiration of the first timer and/or the first timer not running.

In some implementations, the first timer is started or restarted when the first information is transmitted.

In some implementations, the request message is used to request one or more of the following: a requirement for synchronous transmission of a target object, a requirement for coordinated transmission of the target object, a parameter for synchronous transmission of the target object, a parameter for coordinated transmission of the target object, an identifier of the target object, a type of the target object, a requirement for synchronous transmission between at least two objects, a requirement for coordinated transmission between at least two objects, a parameter for synchronous transmission between at least two objects, or a parameter for coordinated transmission between at least two objects; where the target object includes all or part of the at least one object, and if the at least one object includes a plurality of objects, it includes the at least two objects.

In some implementations, the request message includes one or more of the following: identification information of object(s) requested in the request message, a first duration associated with the first information, a reporting period for the first information, a change threshold for a transmission requirement for synchronous transmission or coordinated transmission, a change threshold for a transmission parameter for synchronous transmission or coordinated transmission, or a first timer configuration.

In some implementations, the request message is carried in one or more of the following: system information, a paging message, a radio resource control (RRC) message, uplink control information (UCI), a medium access control control element (MAC CE), or a non-access stratum (NAS) message.

In some implementations, the first information is carried in control plane information, or the first information is transmitted via control plane information.

In some implementations, the control plane information includes one or more of the following: an RRC message, a NAS message, or user equipment (UE) assistance information.

In some implementations, the control plane information carries identification information; or the first information is carried in sub-information of the control plane information, and the sub-information carries identification information; where the identification information includes one or more of the following: identification information of a target object, where the target object is part or all of the at least one object; identification information of a first object among the at least one object; identification information of each object among the at least one object; or identification information of at least two objects, where if the at least one object is a plurality of objects, the at least two objects belong to the plurality of objects.

In some implementations, the identification information includes one or more of the following: identification information of a user equipment, identification information of a radio bearer, an index of a DRB, a QoS flow identifier (QFI), identification information of a data flow, an index of a data flow, identification information of a PDU session, or an index of a PDU session.

In some implementations, the first device is an access network device or a core network device, and the second device is a terminal device.

In some implementations, the control plane information includes one or more of the following: QoS configuration information, information carrying QoS parameters, or time sensitive communication (TSC) assistance information.

In some implementations, the first information is transmitted by a policy control function (PCF) or an application function (AF) to a session management function (SMF), or the first information is carried in a time sensitive communication assistance container (TSCAC) information.

In some implementations, the first device is an access network device, and the second device is a core network device.

In some implementations, the first information is carried in user plane information, or the first information is transmitted via user plane information.

In some implementations, the user plane information includes one or more of the following: a first data packet, a service data adaptation protocol (SDAP) protocol data unit (PDU), a packet data convergence protocol (PDCP) PDU, a MAC CE, a MAC PDU, or UCI.

In some implementations, the first information is carried in a header of the user plane information, or the first information is carried in a payload of the user plane information.

In some implementations, the user plane information carries second information, and the second information is used to indicate that the user plane information carries the first information.

In some implementations, the at least one object includes at least one QoS flow, the SDAP PDU includes a first field, and the first field is used to carry one or more of the following: an identifier of the at least one QoS flow; a type of the at least one QoS flow; an indication of whether a QoS flow corresponding to the first field is a QoS flow associated with the first information; a requirement for synchronous transmission of the at least one QoS flow; a requirement for coordinated transmission of the at least one QoS flow; a parameter for synchronous transmission of the at least one QoS flow; a parameter for coordinated transmission of the at least one QoS flow; an identifier of a QoS flow associated with the first information; an identifier of a QoS flow for which a synchronous transmission requirement exists, where the QoS flow for which a synchronous transmission requirement exists includes the at least one QoS flow; an identifier of a QoS flow for which a coordinated transmission requirement exists, where the QoS flow for which a coordinated transmission requirement exists includes the at least one QoS flow; an identifier of a QoS flow for which synchronous transmission parameters exist, where the QoS flow for which synchronous transmission parameters exist includes the at least one QoS flow; or an identifier of a QoS flow for which coordinated transmission parameters exist, where the QoS flow for which coordinated transmission parameters exist includes the at least one QoS flow.

In some implementations, the SDAP PDU is an SDAP control PDU or an SDAP data PDU.

In some implementations, the first information is carried in the first data packet, and the first data packet satisfies one or more of the following: the first data packet corresponds to the at least one object associated with the first information; a QoS flow of the first data packet is associated with the at least one object; a PDU session of the first data packet is associated with the at least one object; a data flow of the first data packet is associated with the at least one object; or a bearer corresponding to the first data packet is associated with the at least one object.

In some implementations, the first device is an access network device or a core network device, and the second device is a terminal device; or the first device is an access network device, and the second device is a core network device; or the first device is a core network device, and the second device is an access network device or a terminal device.

In some implementations, the at least one object satisfies one or more of the following: QoS flows associated with the at least one object are carried via a same DRB; QoS flows associated with the at least one object are carried via different DRBs; QoS flows associated with the at least one object are carried via a same LCH; QoS flows associated with the at least one object are carried via different LCHs; QoS flows associated with the at least one object are carried via different logical channel groups (LCGs); DRBs or bearers associated with the at least one object are mapped to a same LCH; DRBs or bearers associated with the at least one object are mapped to a same LCG; DRBs or bearers associated with the at least one object are mapped to different LCHs; or DRBs or bearers associated with the at least one object are mapped to different LCGs.

In some implementations, the different DRBs include a plurality of DRBs, and the plurality of DRBs satisfy one or more of the following: configuration parameters of at least two DRBs among the plurality of DRBs match; or logical channel prioritization (LCP) mapping restrictions corresponding to at least two DRBs among the plurality of DRBs match.

In some implementations, the different LCHs include a plurality of LCHs, and configuration parameters of at least two LCHs among the plurality of LCHs match.

In some implementations, the different LCGs include a plurality of LCGs, and the plurality of LCGs satisfy one or more of the following: configuration parameters of at least two LCGs among the plurality of LCGs match; or configuration parameters of LCHs within the plurality of LCGs match.

In some implementations, the at least one object satisfies one or more of the following: data or data packets associated with the at least one object are multiplexed into a same MAC PDU; data or data packets associated with the at least one object are multiplexed into a plurality of consecutive MAC PDUs; data or data packets associated with the at least one object are transmitted synchronously to the first device; or data or data packets associated with the at least one object are transmitted to the first device within a target time period.

In some implementations, the at least one object includes a plurality of objects, the plurality of objects include at least two objects, and the at least two objects satisfy one or more of the following: data or data packets associated with the at least two objects are multiplexed into a same MAC PDU; data or data packets associated with the at least two objects are multiplexed into a plurality of consecutive MAC PDUs; data or data packets associated with the at least two objects are transmitted synchronously to the first device; or data or data packets associated with the at least two objects are transmitted to the first device within a target time period.

In some implementations, one or more objects among the at least one object are target objects, and the target objects satisfy one or more of the following: data or data packets associated with the target objects are multiplexed into a same MAC PDU; data or data packets associated with the target objects are multiplexed into a plurality of consecutive MAC PDUs; data or data packets associated with the target objects are transmitted synchronously to the first device; or data or data packets associated with the target objects are transmitted to the first device within a target time period.

In some implementations, the transmitting unit is further configured to transmit third information to the first device, where the third information is used to indicate one or more of the following: part or all objects among target objects are to be transmitted; data or data packets associated with target objects are to be transmitted; a size of transmission resources required for transmitting target objects; a size of transmission resources required for transmitting object(s) to be transmitted among target objects; data amount information of the object(s) to be transmitted among target objects; a remaining delay for data of the object(s) to be transmitted among the target objects; an allowed delay for data of the object(s) to be transmitted among the target objects; data amount information of objects corresponding to a target remaining delay among the object(s) to be transmitted among the target objects; data amount information of objects corresponding to a target allowed delay among the object(s) to be transmitted among the target objects; or data amount information of objects corresponding to delay status reporting information among the object(s) to be transmitted among the target objects; where the target objects are the at least one object, or the target objects are one or more objects among the at least one object.

In some implementations, the transmitting unit is configured to transmit the third information when a first condition is met, where the first condition includes one or more of the following: the at least one object cannot be multiplexed into a same MAC PDU; the at least one object cannot be multiplexed into a plurality of consecutive MAC PDUs; the at least one object cannot be transmitted synchronously to the first device; or the at least one object cannot be transmitted to the first device within a target time period.

In some implementations, the data associated with the third information satisfies one or more of the following: a scheduling priority of the data associated with the third information is higher than a scheduling priority of first data; a transmission priority of the data associated with the third information is higher than a transmission priority of first data; an LCH priority of the data associated with the third information is higher than an LCH priority of first data; or a multiplexing priority of the data associated with the third information is higher than a multiplexing priority of first data; where the first data is data other than the data associated with the third information among data to be transmitted.

In some implementations, the data associated with the first information satisfies one or more of the following: a scheduling priority of the data associated with the first information is higher than a scheduling priority of second data; a transmission priority of the data associated with the first information is higher than a transmission priority of second data; an LCH priority of the data associated with the first information is higher than an LCH priority of second data; or a multiplexing priority of the data associated with the first information is higher than a multiplexing priority of second data; where the second data is data other than the data associated with the first information among data to be transmitted.

In some implementations, the data associated with the first information may include data of the at least one object or data in data packets of the at least one object.

In some implementations, LCH priorities associated with the at least one object are the same or similar.

In some implementations, the transmitting unit is further configured to transmit fourth information to the first device, where the fourth information is used to indicate whether the second device supports transmitting the first information, or the fourth information is used to indicate whether the second device has available first information.

In some implementations, the first device is an access network device, and the second device is a terminal device or a first core network device; or the first device is a second core network device, and the second device is a terminal device or a first core network device.

FIG. 11 is a schematic diagram of a communication device according to an embodiment of the present application. The communication device 1100 shown in FIG. 11 is a first device, and the communication device 1100 includes a receiving unit 1110.

The receiving unit 1110 is configured to receive first information transmitted by a second device, where the first information is associated with synchronous transmission or coordinated transmission of at least one object.

In some implementations, the first information is used to indicate one or more of the following: a synchronous transmission requirement exists for the at least one object; a coordinated transmission requirement exists for the at least one object; a parameter for synchronous transmission of the at least one object; a parameter for coordinated transmission of the at least one object; identification information corresponding to the at least one object; a type corresponding to the at least one object; whether the at least one object corresponds to target identification information; whether the at least one object corresponds to a target type; a requirement for synchronous transmission between at least two objects; a requirement for coordinated transmission between at least two objects; a parameter for synchronous transmission between at least two objects; a parameter for coordinated transmission between at least two objects; performing synchronous transmission between at least two objects; performing coordinated transmission between at least two objects; whether at least two objects correspond to same identification information; whether at least two objects correspond to a same type; whether at least two objects correspond to target identification information; whether at least two objects correspond to a target type; an association relationship between at least two objects; or a binding relationship between at least two objects; where if the at least one object includes a plurality of objects, the at least one object includes the at least two objects..

In some implementations, an object among the at least one object includes one of the following: a Quality of Service (QoS) flow, a data flow, a terminal device, a protocol data unit (PDU) session, or a radio bearer.

In some implementations, the first information includes identification information, and the identification information includes one or more of the following: identification information of a target object, where the target object is part or all of the at least one object; identification information of a first object among the at least one object; identification information of each of the at least one object; or identification information used for identifying at least two objects; where if the at least one object includes a plurality of objects, the at least one object includes the at least two objects.

In some implementations, the transmission of the first information is triggered based on one or more of the following: a period; a first event; a request message transmitted by the first device; an enabling indication used to enable the second device to transmit the first information; a capability of the second device that is associated with synchronous transmission or coordinated transmission of the at least one object; whether the first device has obtained the first information; or whether the second device has available or valid first information.

In some implementations, the first event includes one or more of the following: a first duration is exceeded; the second device is configured to transmit the first information of the at least one object; the first information of the at least one object has not yet been transmitted; the first information of the at least one object has not yet been transmitted; a requirement for synchronous transmission of the at least one object; a requirement for coordinated transmission of the at least one object changes; a parameter for synchronous transmission of the at least one object changes; a parameter for coordinated transmission of the at least one object changes; an identifier for synchronous transmission of the at least one object changes; a type for synchronous transmission of the at least one object changes; an identifier for coordinated transmission of the at least one object changes; a type for coordinated transmission of the at least one object changes; an identifier for synchronous transmission between at least two objects changes; a type for synchronous transmission between at least two objects changes; an identifier for coordinated transmission between at least two objects changes; a type for coordinated transmission between at least two objects changes; a requirement for synchronous transmission between at least two objects changes; a requirement for coordinated transmission between at least two objects changes; a parameter for synchronous transmission between at least two objects changes; a parameter for coordinated transmission between at least two objects changes; a change in a requirement for synchronous transmission of the at least one object is greater than or equal to a first change threshold; a change in a requirement for coordinated transmission of the at least one object is greater than or equal to a second change threshold; a change in a parameter for synchronous transmission of the at least one object is greater than or equal to a third change threshold; a change in a parameter for coordinated transmission of the at least one object is greater than or equal to a fourth change threshold; a change in a parameter for synchronous transmission between at least two objects is greater than or equal to a fifth change threshold; a change in a parameter for coordinated transmission between at least two objects is greater than or equal to a sixth change threshold; a change in a requirement for synchronous transmission between at least two objects is greater than or equal to a seventh change threshold; or a change in a requirement for coordinated transmission between at least two objects is greater than or equal to an eighth change threshold.

In some implementations, the first duration is a duration during which transmission of the first information is prohibited or not allowed; or the first duration is a duration during which transmission of the first information of the at least one object is prohibited or not allowed.

In some implementations, a configuration granularity of the first duration is one object among the at least one object; and/or the first duration is used for one object among the at least one object.

In some implementations, the object associated with the configuration granularity is different from the object for which the first duration is used, or the object associated with the configuration is same as the object for which the first duration is used.

In some implementations, the first duration is determined based on a first timer, and the first event includes the expiration of the first timer and/or the first timer not running.

In some implementations, the first timer is started or restarted when the first information is transmitted.

In some implementations, the request message is used to request one or more of the following: a requirement for synchronous transmission of a target object; a requirement for coordinated transmission of the target object; a parameter for synchronous transmission of the target object; a parameter for coordinated transmission of the target object; an identifier of the target object; a type of the target object; a requirement for synchronous transmission between at least two objects; a requirement for coordinated transmission between at least two objects; a parameter for synchronous transmission between at least two objects; or a parameter for coordinated transmission between at least two objects; where the target object includes all or part of the at least one object, and if the at least one object includes a plurality of objects, it includes the at least two objects.

In some implementations, the request message includes one or more of the following: identification information of object(s) requested in the request message, a first duration associated with the first information, a reporting period for the first information, a change threshold for a requirement for synchronous transmission or coordinated transmission, a change threshold for a transmission parameter for synchronous transmission or coordinated transmission, or a first timer configuration.

In some implementations, the request message is carried in one or more of the following: system information, a paging message, a radio resource control (RRC) message, uplink control information (UCI), a medium access control control element (MAC CE), or a non-access stratum (NAS) message.

In some implementations, the first information is carried in control plane information, or the first information is transmitted via control plane information.

In some implementations, the control plane information includes one or more of the following: an RRC message, a NAS message, or user equipment (UE) assistance information.

In some implementations, the control plane information carries identification information; or the first information is carried in sub-information of the control plane information, and the sub-information carries identification information; where the identification information includes one or more of the following: identification information of a target object, where the target object is part or all of the at least one object; identification information of a first object among the at least one object; identification information of each object among the at least one object; or identification information of at least two objects, where if the at least one object is a plurality of objects, the at least two objects belong to the plurality of objects.

In some implementations, the identification information includes one or more of the following: identification information of a user equipment, identification information of a radio bearer, an index of a DRB, a QoS flow identifier (QFI), identification information of a data flow, an index of a data flow, identification information of a PDU session, or an index of a PDU session.

In some implementations, the first device is an access network device or a core network device, and the second device is a terminal device.

In some implementations, the control plane information includes one or more of the following: QoS configuration information, information carrying QoS parameters, or time sensitive communication (TSC) assistance information.

In some implementations, the first information is transmitted by a PCF or an AF to an SMF, or the first information is carried in TSCAC information by the PCF or AF.

In some implementations, the first device is an access network device, and the second device is a core network device.

In some implementations, the first information is carried in user plane information, or the first information is transmitted via user plane information.

In some implementations, the user plane information includes one or more of the following: a first data packet; a service data adaptation protocol (SDAP) protocol data unit (PDU), a packet data convergence protocol (PDCP) PDU, a MAC CE, a MAC PDU, or UCI.

In some implementations, the first information is carried in a header of the user plane information, or the first information is carried in a payload of the user plane information.

In some implementations, the user plane information carries second information, and the second information is used to indicate that the user plane information carries the first information.

In some implementations, the at least one object includes at least one QoS flow, the SDAP PDU includes a first field, and the first field is used to carry one or more of the following: an identifier of the at least one QoS flow; a type of the at least one QoS flow; an indication of whether the QoS flow corresponding to the first field is the QoS flow associated with the first information; a requirement for synchronous transmission of the at least one QoS flow; a requirement for coordinated transmission of the at least one QoS flow; a parameter for synchronous transmission of the at least one QoS flow; a parameter for coordinated transmission of the at least one QoS flow; an identifier of a QoS flow associated with the first information; an identifier of a QoS flow for which a synchronous transmission requirement exists, where the QoS flow for which a synchronous transmission requirement exists includes the at least one QoS flow; an identifier of a QoS flow for which a coordinated transmission requirement exists, where the QoS flow for which a coordinated transmission requirement exists includes the at least one QoS flow; an identifier of a QoS flow for which synchronous transmission parameters exist, where the QoS flow for which synchronous transmission parameters exist includes the at least one QoS flow; or an identifier of a QoS flow for which coordinated transmission parameters exist, where the QoS flow for which coordinated transmission parameters exist includes the at least one QoS flow.

In some implementations, the SDAP PDU is an SDAP control PDU or an SDAP data PDU.

In some implementations, the first information is carried in a first data packet, and the first data packet satisfies one or more of the following: the first data packet corresponds to the at least one object associated with the first information; a QoS flow of the first data packet is associated with the at least one object; a PDU session of the first data packet is associated with the at least one object; a data flow of the first data packet is associated with the at least one object; or a bearer corresponding to the first data packet is associated with the at least one object.

In some implementations, the first device is an access network device or a core network device, and the second device is a terminal device; or the first device is an access network device, and the second device is a core network device; or the first device is a core network device, and the second device is an access network device or a terminal device.

In some implementations, the at least one object satisfies one or more of the following: QoS flows associated with the at least one object are carried via a same DRB; QoS flows associated with the at least one object are carried via different DRBs; QoS flows associated with the at least one object are carried via a same LCH; QoS flows associated with the at least one object are carried via different LCHs; QoS flows associated with the at least one object are carried via different logical channel groups (LCGs); DRBs or bearers associated with the at least one object are mapped to a same LCH; DRBs or bearers associated with the at least one object are mapped to a same LCG; DRBs or bearers associated with the at least one object are mapped to different LCHs; or DRBs or bearers associated with the at least one object are mapped to different LCGs.

In some implementations, the different DRBs include a plurality of DRBs, and the plurality of DRBs satisfy one or more of the following: configuration parameters of at least two DRBs among the plurality of DRBs match; or logical channel prioritization (LCP) mapping restrictions corresponding to at least two DRBs among the plurality of DRBs match.

In some implementations, the different LCHs include a plurality of LCHs, and configuration parameters of at least two LCHs among the plurality of LCHs match.

In some implementations, the different LCGs include a plurality of LCGs, and the plurality of LCGs satisfy one or more of the following: configuration parameters of at least two LCGs among the plurality of LCGs match; or configuration parameters of LCHs within the plurality of LCGs match.

In some implementations, the at least one object satisfies one or more of the following: data or data packets associated with the at least one object are multiplexed into a same MAC PDU; data or data packets associated with the at least one object are multiplexed into a plurality of consecutive MAC PDUs; data or data packets associated with the at least one object are transmitted synchronously to the first device; or data or data packets associated with the at least one object are transmitted to the first device within a target time period.

In some implementations, the at least one object includes a plurality of objects, and the plurality of objects include at least two objects that satisfy one or more of the following: data or data packets associated with the at least two objects are multiplexed into a same MAC PDU; data or data packets associated with the at least two objects are multiplexed into a plurality of consecutive MAC PDUs; data or data packets associated with the at least two objects are transmitted synchronously to the first device; or data or data packets associated with the at least two objects are transmitted to the first device within a target time period.

In some implementations, one or more objects among the at least one object are target objects, and the target objects satisfy one or more of the following: data or data packets associated with the target objects are multiplexed into a same MAC PDU; data or data packets associated with the target objects are multiplexed into a plurality of consecutive MAC PDUs; data or data packets associated with the target objects are transmitted synchronously to the first device; or data or data packets associated with the target objects are transmitted to the first device within a target time period.

In some implementations, the receiving unit is further configured to receive third information transmitted by a second device, where the third information is used to indicate one or more of the following: part or all of target objects are to be transmitted; data or data packets associated with target objects are to be transmitted; a size of transmission resources required for transmitting target objects; a size of transmission resources required for transmitting objects to be transmitted among target objects; data amount information of objects to be transmitted among target objects; a remaining delay for data of objects to be transmitted among target objects; an allowed delay for data of objects to be transmitted among target objects; data amount information of an object corresponding to a target allowed delay among objects to be transmitted among target objects; data amount information of objects corresponding to a target remaining delay among objects to be transmitted among target objects; or data amount information of an object corresponding to delay status reporting information among objects to be transmitted among target objects; where the target objects are the at least one object, or the target objects are one or more objects of the at least one object.

In some implementations, the receiving, by the first device, the third information transmitted by the second device includes: receiving, by the first device when a first condition is met, the third information transmitted by the second device; where the first condition includes one or more of the following: the at least one object cannot be multiplexed into a same MAC PDU; the at least one object cannot be multiplexed into a plurality of consecutive MAC PDUs; the at least one object cannot be transmitted synchronously to the first device; or the at least one object cannot be transmitted to the first device within a target time period.

In some implementations, the data associated with the third information satisfies one or more of the following: a scheduling priority of the data associated with the third information is higher than a scheduling priority of first data; a transmission priority of the data associated with the third information is higher than a transmission priority of first data; an LCH priority of the data associated with the third information is higher than an LCH priority of first data; or a multiplexing priority of the data associated with the third information is higher than a multiplexing priority of first data; where the first data is data other than the data associated with the third information among data to be transmitted.

In some implementations, the first information is associated with the synchronous transmission or coordinated transmission of data or data packets of the at least one object, and data associated with the first information satisfies one or more of the following: a scheduling priority of the data associated with the first information is higher than a scheduling priority of second data; a transmission priority of the data associated with the first information is higher than a transmission priority of second data; an LCH priority of the data associated with the first information is higher than an LCH priority of second data; or a multiplexing priority of the data associated with the first information is higher than a multiplexing priority of second data; where the second data is data other than the data associated with the first information among data to be transmitted.

In some implementations, LCH priorities associated with the at least one object are identical or similar.

In some implementations, the receiving unit is further configured to receive fourth information transmitted by the second device; where the fourth information is used to indicate whether the second device supports transmitting the first information, or the fourth information is used to indicate whether the second device has available first information.

In some implementations, the first device is an access network device, and the second device is a terminal device or a first core network device; or the first device is a second core network device, and the second device is a terminal device or a first core network device.

In an optional embodiment, the transmitting unit 1010 may be a transceiver 1230. The communication device 1000 may also include a processor 1210 and a memory 1220, as shown in FIG. 12.

In an optional embodiment, the receiving unit 1110 may be a transceiver 1230. The communication device 1100 may also include a processor 1210 and a memory 1220, as shown in FIG. 12.

FIG. 12 is a schematic block diagram of a communication apparatus according to an embodiment of the present application. The dashed lines in FIG. 12 indicate that the unit or module is optional. The apparatus 1200 can be used to implement the methods described in the foregoing method embodiments. The apparatus 1200 may be a chip, a terminal device, or a network device.

The apparatus 1200 may include one or more processors 1210. The processor 1210 can support the apparatus 1200 in implementing the methods described in the foregoing method embodiments. The processor 1210 may be a general-purpose processor or a special-purpose processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. A general-purpose processor may be a microprocessor, or the processor may be any conventional processor.

The apparatus 1200 may also include one or more memories 1220. The memory 1220 stores a program which is executable on the processor 1210 to cause the processor 1210 to perform the methods described in the foregoing method embodiments. The memory 1220 may be independent of or integrated with the processor 1210.

The apparatus 1200 may also include a transceiver 1230. The processor 1210 can communicate with other devices or chips via the transceiver 1230. For example, the processor 1210 can transmit and receive data with other devices or chips via the transceiver 1230.

The embodiments of the present application also provide a non-transitory computer-readable storage medium configured to store a program. The non-transitory computer-readable storage medium may be applied to the terminal or network device provided in the embodiments of the present application, and the program causes a computer to execute the methods performed by the terminal or network device in the various embodiments of the present application.

The embodiments of the present application also provide a computer program product. The computer program product includes a program. The computer program product may be applied to the terminal or network device provided in the embodiments of the present application, and the program causes a computer to execute the methods performed by the terminal or network device in the various embodiments of the present application.

The embodiments of the present application also provide a computer program. The computer program may be applied to the terminal or network device provided in the embodiments of the present application, and the computer program causes a computer to execute the methods performed by the terminal or network device in the various embodiments of the present application.

It should be understood that the terms “system” and “network” may be used interchangeably in the present application. Furthermore, the terminology used in the present application is for the purpose of describing particular embodiments only and is not intended to limit the application. The terms “first,” “second,” “third,” and “fourth” in the specification, claims, and the accompanying drawings of the present application are used to distinguish different objects and not to describe a specific order. In addition, the terms “including” and “having,” and any variations thereof, are intended to cover a non-exclusive inclusion.

In the embodiments of the present application, the term “indication” may refer to a direct indication, an indirect indication, or an association relationship. For example, A indicating B can mean that A directly indicates B, e.g., B can be obtained from A; it can also mean that A indirectly indicates B, e.g., A indicates C, and B can be obtained from C; it can also mean that there is an association relationship between A and B.

In the embodiments of the present application, “B corresponding to A” means that B is associated with A, and B can be determined based on A. However, it should also be understood that determining B based on A does not imply that B is determined solely based on A; B can also be determined based on A and/or other information.

In the embodiments of the present application, the term “corresponding” may indicate a direct or indirect correspondence relationship between two entities, an association relationship between them, or a relationship such as indicating and being indicated, or configuring and being configured.

In the embodiments of the present application, “predefined” or “preconfigured” may be implemented by prestoring corresponding codes, tables, or other means that can be used to indicate relevant information in a device (such as, a terminal device, or a network device). The present application does not limit the specific implementation thereof. For example, “predefined” may refer to being defined in a protocol.

In the embodiments of the present application, the term “protocol” may refer to a standard protocol in the communication field, such as an LTE protocol, an NR protocol, and related protocols applied in future communication systems, which is not limited in the present application.

In the embodiments of the present application, the term “and/or” is merely a way of describing the relationship between associated objects, and it indicates that three relationships can exist. For example, A and/or B can mean: A exists alone, both A and B exist, or B exists alone. In addition, the character “/” herein generally indicates an “or” relationship between the associated objects before and after the character “/”.

In the various embodiments of the present application, the sequence numbers of the foregoing processes does not imply the order of execution. The execution order of each process should be determined by its function and inherent logic, and should not constitute any limitation on the implementation process of the embodiments of the present application.

In the several embodiments provided in the present application, it should be understood that the disclosed systems, apparatuses, and methods can be implemented in other ways. For example, the apparatus embodiments described above are merely illustrative. For example, the division of units is only a logical functional division, and there may be other ways of division in actual implementation. For example, multiple units or components can be combined or integrated into another system, or some features can be ignored or not executed. In another aspect, the coupling or direct coupling or communication connection shown or discussed may be through some interfaces, and the indirect coupling or communication connection between apparatuses or units may be electrical, mechanical, or in other forms.

The units described as separate components may or may not be physically separate, and the components displayed as units may or may not be physical units, i.e., they may be located in one place or distributed across multiple network units. Some or all of the units may be selected according to actual needs to achieve the objectives of the solutions of the embodiments.

In addition, the functional units in the various embodiments of the present application may be integrated into one processing unit, or each unit may exist alone physically, or two or more units may be integrated into one unit.

In the above embodiments, all or part of the implementation can be realized through software, hardware, firmware, or any combination thereof. When implemented by software, it can be realized in whole or in part in the form of a computer program product. The computer program product includes one or more computer instructions. When the computer program instructions are loaded and executed on a computer, the processes or functions described in the embodiments of the present application are generated in whole or in part. The computer may be a general-purpose computer, a special-purpose computer, a computer network, or another programmable apparatus. The computer instructions may be stored in a non-transitory computer-readable storage medium or transmitted from one non-transitory computer-readable storage medium to another. For example, the computer instructions may be transmitted from a website, computer, server, or data center to another website, computer, server, or data center via a wired (e.g., coaxial cable, optical fiber, digital subscriber line (DSL)) or wireless (e.g., infrared, radio, microwave, etc.) means. The non-transitory computer-readable storage medium may be any available medium that can be accessed by a computer or a data storage device such as a server or data center that integrates one or more available media. The available medium may be a magnetic medium (e.g., a floppy disk, hard disk, magnetic tape), an optical medium (e.g., a digital video disc (DVD)), or a semiconductor medium (e.g., a solid state disk (SSD)), etc.

The foregoing descriptions are merely specific embodiments of the present application, but the protection scope of the present application is not limited thereto. Any person skilled in the art can easily conceive of changes or replacements within the technical scope disclosed in the present application, which should be covered by the protection scope of the present application. Therefore, the protection scope of the present application shall be subject to the protection scope of the claims.

What is claimed is:

1. A wireless communication method, comprising:
transmitting, by a second device to a first device, first information, wherein the first information is associated with synchronous transmission or coordinated transmission of at least one object.

2. The method according to claim 1, wherein the first information is used to indicate one or more of the following: a synchronous transmission requirement exists for the at least one object;
a coordinated transmission requirement exists for the at least one object; a parameter for synchronous transmission of the at least one object; a parameter for coordinated transmission of the at least one object; identification information corresponding to the at least one object; a parameter for coordinated transmission between at least two objects; performing synchronous transmission between at least two objects; performing coordinated transmission between at least two objects; whether at least two objects correspond to same identification information; wherein if the at least one object includes a plurality of objects, the plurality of objects include the at least two objects.

3. The method according to claim 2, wherein the identification information comprises one or more of the following: identification information of a target object, wherein the target object is part or all of the at least one object; identification information of a first object among the at least one object; identification information of each object among the at least one object; or identification information for identifying at least two objects, wherein if the at least one object includes a plurality of objects, the plurality of objects include the at least two objects.

4. The method according to claim 1, wherein an object among the at least one object comprises one of the following: a Quality of Service (QoS) flow, a data flow, a terminal device, a protocol data unit (PDU) session, or a radio bearer.

5. The method according to claim 1, wherein the first information is carried in control plane information, or the first information is transmitted via control plane information.

6. The method according to claim 5, wherein the control plane information comprises one or more of the following: an RRC message, a NAS message, or user equipment (UE) assistance information.

7. The method according to claim 5, wherein the control plane information comprises one or more of the following: QoS configuration information, information carrying QoS parameters, or time sensitive communication (TSC) assistance information.

8. The method according to claim 7, wherein the first information is transmitted by a policy control function (PCF) or an application function (AF) to a session management function (SMF), or the first information is carried in a time sensitive communication assistance container (TSCAC) by the PCF or AF.

9. The method according to claim 7, wherein the first device is an access network device, and the second device is a core network device.

10. A wireless communication method, comprising: receiving, by a first device, first information transmitted by a second device, wherein the first information is associated with synchronous transmission or coordinated transmission of at least one object.

11. The method according to claim 10, wherein the first information is used to indicate one or more of the following: a synchronous transmission requirement exists for the at least one object; a coordinated transmission requirement exists for the at least one object; a parameter for synchronous transmission of the at least one object; a parameter for coordinated transmission of the at least one object; identification information corresponding to the at least one object; a parameter for coordinated transmission between at least two objects; performing synchronous transmission between at least two objects; performing coordinated transmission between at least two objects; whether at least two objects correspond to same identification information; wherein if the at least one object includes a plurality of objects, the plurality of objects include the at least two objects.

12. The method according to claim 11, wherein the identification information comprises one or more of the following: identification information of a target object, wherein the target object is part or all of the at least one object; identification information of a first object among the at least one object; identification information of each of the at least one object; or identification information used for identifying at least two objects; wherein if the at least one object includes a plurality of objects, the plurality of objects include the at least two objects.

13. The method according to claims 10, wherein an object among the at least one object comprises one of the following: a Quality of Service (QoS) flow, a data flow, a terminal device, a protocol data unit (PDU) session, or a radio bearer.

14. The method according to claim 10, wherein the first information is carried in control plane information, or the first information is transmitted via control plane information.

15. The method according to claim 14, wherein the control plane information comprises one or more of the following: an RRC message, a NAS message, or user equipment (UE) assistance information.

16. The method according to claim 14, wherein the control plane information comprises one or more of the following: QoS configuration information, information carrying QoS parameters, or time sensitive communication (TSC) assistance information.

17. The method according to claim 16, wherein the first information is transmitted by a PCF or an AF to an SMF, or the first information is carried in TSCAC by the PCF or AF.

18. The method according to claim 16, wherein the first device is an access network device, and the second device is a core network device.

19. A communication device, wherein the communication device is a second device and comprises a transceiver, a memory, and a processor, wherein the memory is used to store a program, and the processor is used to invoke the program in the memory and control the transceiver to receive or transmit signals, to cause the communication device to perform:
transmitting to a first device first information, wherein the first information is associated with synchronous transmission or coordinated transmission of at least one object.

20. The communication device according to claim 19, wherein the first information is used to indicate one or more of the following: a synchronous transmission requirement exists for the at least one object; a coordinated transmission requirement exists for the at least one object; a parameter for synchronous transmission of the at least one object; a parameter for coordinated transmission of the at least one object; identification information corresponding to the at least one object; a parameter for coordinated transmission between at least two objects; performing synchronous transmission between at least two objects; performing coordinated transmission between at least two objects; whether at least two objects correspond to same identification information; wherein if the at least one object includes a plurality of objects, the plurality of objects include the at least two objects.
